(19) United States
(12) Patent Application Publication
(10) Pub. No.: US 2023/0129265 A1
(43) Pub. Date: Apr. 27, 2023

(54) SYSTEMS AND METHODS FOR GENERATING LABORATORY WATER AND DISTRIBUTING LABORATORY WATER AT DIFFERENT TEMPERATURES

(71) Applicant: Regeneron Pharmaceuticals, Inc., Tarrytown, NY (US)

(72) Inventor: Michelle LaFond, Pleasantville, NY (US)

(21) Appl. No.: 17/973,638

(22) Filed: Oct. 26, 2022

Related U.S. Application Data
(60) Provisional application No. 63/271,826, filed on Oct. 26, 2021.

(51) Int. Cl. C02F 9/00; C02F 1/00; B01L 7/00

(52) U.S. Cl. CPC C02F 9/005; C02F 1/008; B01L 7/00; C02F 1/001; C02F 1/42

(57) ABSTRACT

A laboratory water generation and distribution system capable of distributing laboratory water at different temperatures is disclosed. A laboratory water generation section is configured to receive potable water and treat the potable water to generate laboratory water. A laboratory water distribution section comprises a laboratory water storage tank and a main distribution loop fluidly communicating with the laboratory water storage tank to receive the laboratory water therefrom. The laboratory water distribution section further comprises a sub distribution loop operatively connected to the main distribution loop via a valve to receive the laboratory water therefrom. The sub distribution loop returns to the main distribution loop and dispenses the laboratory water to the main distribution loop.

This Application claims priority to U.S. application Ser. No. 63/271,826, filed Oct. 26, 2021, which is hereby incorporated by reference in its entirety.

### TECHNICAL FIELD

The present disclosure provides inventions for generating laboratory water and distributing laboratory water at different temperatures, typically room temperature and above room temperature, for various purposes in laboratories and biological/pharmaceutical production facilities.

### BACKGROUND

Modern laboratories and biological/pharmaceutical production facilities require reliable sources of purified water for a variety of purposes. Purposes include washing glassware and fermentation tanks, creating aqueous solutions, conducting analyses, preparing growth media for cells, and use in autoclaving for sterilizing materials. Often, certain tasks require water to be above room temperature, such as in the solubilizing of cell growth media for the propagation of cells.

In addition to the purity of the water, precise temperature control of the water is often required for various applications. While many applications may utilize water at a chilled to ambient temperature (for example, about 60° F. to about 80° F.) depending on the season and the location of the laboratories and biological/pharmaceutical production facilities, some applications may require warmer water at precise temperatures. Further, due to the time-sensitive nature of various processes, immediate availability of precisely heated water is desirable.

Typically, generation of highly purified water is expensive, time consuming, and energy intensive due to the equipment, consumables, and degree of precision required. Accordingly, there is value in reducing waste of the purified water. However, efficient use of the water is often difficult to balance with the emphasis on immediate availability. Conventionally, water at ambient temperature may be drawn into a container and separately heated. However, this process requires additional time and is unlikely to precisely heat the water to a specified temperature without additional monitoring. Furthermore, such processes generally result in waste because laboratory water removed from the distribution system cannot easily be returned thereto without risk of contamination.

Accordingly, it would be advantageous to have a water distribution system capable of providing water at both ambient temperatures and set point temperatures on demand whilst minimizing waste. It would be further advantageous for the water distribution system to provide careful monitoring of the water in order to provide the precise conditions required for complex applications.

### SUMMARY OF THE INVENTIONS

Provided herein are laboratory water generation and distribution systems capable of distributing laboratory water at different temperatures, wherein the system comprises: (A) a laboratory water generation section configured to treat potable water to generate laboratory water; (B) a laboratory water distribution section comprising: (1) a laboratory water storage tank, (2) a main distribution loop in fluid communication with the laboratory water storage tank and configured to receive the laboratory water therefrom to distribute laboratory water through at least one outlet at a first temperature range, and (3) a sub distribution loop operatively connected to the main distribution loop via a valve and configured to receive the laboratory water therefrom to distribute laboratory water through at least one outlet at a second temperature range, wherein the sub distribution loop also can return dispensed laboratory water to the main distribution loop or out of the system altogether, such as a waste water drain; (C) an Operator Interface Terminal (OIT); and (D) one or more processors. In some embodiments, the main distribution loop and the sub distribution loop continuously circulate laboratory water. In some embodiments, the sub distribution loop can return laboratory water to the main distribution loop, preferably after a period of time to allow the laboratory water to cool from the second temperature. According to some embodiments, when heated laboratory water in the sub distribution loop is no longer needed, a drain valve is opened to allow the laboratory water in the sub distribution loop to cool (for example, to a baseline temperature), after which, the drain valve is closed and the cooled laboratory water is allowed to pass from the sub distribution loop to the main distribution loop. The functions described may be controlled by an operator, a user, or a programmer.

The laboratory water generation section can include a multimedia filter, a cartridge filter, a water softening medium, an activated carbon bed, a reverse osmosis unit, a UV light, an ion exchange bed vessel and a mixed bed ion exchange vessel. The laboratory water in the main and sub distribution loops may be controlled by an Operator Interface Terminal (OIT).

The system may also include one or more processors configured to receive, through an operator interface terminal (OIT), heating input related to a set point temperature for water, heat a first quantity of water within the sub distribution loop from a baseline temperature to the set point temperature, maintain the first quantity of water at the set point temperature for a period of time, preserve a second quantity of water within the main distribution loop at the baseline temperature for the period of time, and cool, in response to a trigger, the first quantity of water from the set point temperature to the baseline temperature. The heating input may include a request for heated water at the set point temperature and/or a time limit. The trigger may be a notification that the period of time has reached a predetermined time limit and/or a user-selected time limit. The trigger may also be termination by the user via the OIT. The processor may also be configured to close the valve in response to the heating input, monitor the temperature of the first quantity of water, and open the valve when the temperature is equal to the baseline temperature.

The processor may also be configured to receive, through an OIT, cooling input related to a baseline temperature, cool a first quantity of water in the main distribution loop from an initial temperature to a baseline temperature, maintain the first quantity of water at the baseline temperature for a period of time, and cease maintenance of the first quantity of water in response to a trigger. The cooling input comprises a request for cooled water at the baseline temperature and/or a time limit. The trigger may comprise a notification that the period of time has reached a predetermined time limit and/or a user-selected time limit. The trigger may also be termination by the user via the OIT.

The laboratory water in the main distribution loop may maintained at about an ambient temperature, such as between about 15.5° C. (60° F.) to about 30° C. (86° F.), in some embodiments about 18° C. (64.4° F.) to about 25° C. (77° F.), and still in some embodiments 18° C. (64.4° F.) to about 22° C. (71.6° F.). The sub distribution loop may be configured to heat and maintain the laboratory water in the sub distribution loop to a temperature above ambient, such as between about 50° C. (122° F.) to about 60° C. (140° F.), in some embodiments about 53° C. (127.4° F.) to about 57° C. (134.6° F.), in some embodiments about 55° C. (131° F.) and later cool the heated laboratory water in the sub distribution loop to a temperature about ambient temperature prior to returning the laboratory water to the main distribution loop, storing tank or dispensing the laboratory water to a waste drain. These temperature ranges can apply to all embodiments of the inventions.

The sub distribution loop may be operatively connected to a heat exchanger to heat and maintain the laboratory water. The system may include outlets connected to the main distribution loop and the sub distribution loop including laboratory faucets, and faucets for mixing buffers and media. The main distribution loop returns the laboratory water to the laboratory water storage tank.

Additionally, there are provided methods of generating laboratory water and distributing laboratory water at different temperatures, the method comprising the steps of: (A) treating potable water using laboratory water generation section to generate laboratory water; and (B) distributing laboratory water using a laboratory water distribution section comprising: (1) a laboratory water storage tank, (2) a main distribution loop in fluid communication with the laboratory water storage tank and receiving the laboratory water therefrom to distribute laboratory water through at least one outlet at a first temperature range, and (3) a sub distribution loop operatively connected to the main distribution loop via a valve and receiving the laboratory water therefrom to distribute laboratory water through at least one outlet at a second temperature range, wherein the sub distribution loop also can return laboratory water to the main distribution loop, wherein the distributing is controlled by a at least one processor. The functions described may be controlled by an operator, a user, or a programmer.

The laboratory water generation section can include a multimedia filter, a cartridge filter, a water softening medium, an activated carbon bed, a reverse osmosis unit, a UV light, an ion exchange bed vessel and a mixed bed ion exchange vessel. The laboratory water in the sub distribution loop may be controlled by an Operator Interface Terminal (OIT).

The system may also include one or more processors configured to receive, through an operator interface terminal (OIT), heating input related to a set point temperature for water, heat a first quantity of water within the sub distribution loop from a baseline temperature to the set point temperature, maintain the first quantity of water at the set point temperature for a period of time, preserve a second quantity of water within the main distribution loop at the baseline temperature for the period of time, and cool, in response to a trigger, the first quantity of water from the set point temperature to the baseline temperature. The heating input may include a request for heated water at the set point temperature and/or a time limit. The trigger may be a notification that the period of time has reached a predetermined time limit and/or a user-selected time limit. The trigger may also be termination by the user via the OIT. The processor may also be configured to close the valve in response to the heating input, monitor the temperature of the first quantity of water, and open the valve when the temperature is equal to the baseline temperature.

The processor may also be configured to receive, through an OIT or the like, cooling input related to a baseline temperature, cool a first quantity of water in the main distribution loop from an initial temperature to a baseline temperature, maintain the first quantity of water at the baseline temperature for a period of time, and cease maintenance of the first quantity of water in response to a trigger. The cooling input comprises a request for cooled water at the baseline temperature and/or a time limit. The trigger may comprise a notification that the period of time has reached a predetermined time limit and/or a user-selected time limit. The trigger may also be termination by the user via the OIT.

The laboratory water in the main distribution loop may maintained at a temperature range disclosed above, and using a chiller as needed. The sub distribution loop may be configured to heat and maintain the laboratory water in the sub distribution loop to a temperature range disclosed above and later cool the laboratory water in the sub distribution loop to a temperature that is about ambient. The sub distribution loop may be operatively connected to a heat exchanger to heat and maintain the laboratory water. The system may include distribution outlets connected to the main distribution loop and the sub distribution loop through outlets, such as laboratory faucets, and faucets for mixing buffers and media. The main distribution loop returns the laboratory water to the laboratory water storage tank.

There is also provided a computer-implemented method of regulating water temperature within a distribution system is also provided. The method comprises receiving, by an input device, initiation input related to a set point temperature for water; heating a first quantity of water within a sub distribution loop of the distribution system from a baseline temperature to the set point temperature; maintaining the first quantity of water at the set point temperature for a time period; preserving a second quantity of water within a main distribution loop of the distribution system at the baseline temperature during the time period; and cooling, in response to a trigger, the first quantity of water from the set point temperature to the baseline temperature.

The input may be a request for heated water and/or a set point temperature. The input device comprises a operator interface including a display and one or more buttons. The sub distribution loop may be segregated from the main distribution loop during the time period and may fluidly communicates with the main distribution loop following the time period. The trigger may be a time limit and the first quantity of water may be cooled when the time period reaches the time limit. The trigger may also be termination by a user from the input device. The trigger may also be an indication of one or more of a system error, an environmental condition, and a water condition. The method may further comprise closing a valve between the main distribution loop and the sub distribution loop in response to the input; monitoring, after the period of time, a temperature of the first quantity of water; and opening the valve when the temperature is equal to the baseline temperature.

Also provided herein are laboratory water generation and distribution systems capable of distributing laboratory water at different temperatures, wherein the system comprises: (A) a laboratory water generation section configured to treat potable water to generate laboratory water; (B) a laboratory water storage section comprising a laboratory water storage tank in fluid communication with the laboratory water generation section and configured to receive the laboratory water therefrom; (C) a laboratory water distribution section comprising: (1) at least one cooled water distribution loop in fluid communication with the laboratory water storage tank, the cooled water distribution loop configured to receive the laboratory water from the storage tank and to distribute the laboratory water at a first temperature range through one or more outlets, and (2) at least one heated water distribution loop in fluid communication with the laboratory water storage tank, the heated water distribution loop configured to receive the laboratory water from the storage tank and to distribute the laboratory water at a second temperature range through one or more outlets, the second temperature range exceeding the first temperature range; (D) an Operator Interface Terminal (OIT); and (E) a processor operatively coupled to one or more of the laboratory water generation section, the laboratory water storage section, the laboratory water distribution section, and the OIT, wherein the heated water distribution loop is configured to recycle a quantity of the laboratory water therein by returning same to the storage tank. The systems can contain two or more cooled water distribution loops and two or more heated distribution loops.

In some embodiments, the laboratory water generation section can include first and second cooled water distribution loops in fluid communication with the laboratory water storage tank. In some embodiments, the laboratory water generation section is configured to generate reverse osmosis de-ionized (RODI) water, the cooled water distribution loop is configured to distribute cooled reverse osmosis de-ionized (CRODI) water, and the heated water distribution loop is configured to distribute heated reverse osmosis de-ionized (HRODI) water. In some embodiments, the cooled water distribution loop and/or the heated water distribution loop are operatively coupled to the storage tank via one or more valves. The laboratory water generation section can include a multimedia filter, a cartridge filter, a water softening medium, an activated carbon bed, a reverse osmosis unit, a UV light, an ion exchange bed vessel and a mixed bed ion exchange vessel. The laboratory water in the cooled and heated distribution loops may be controlled by an Operator Interface Terminal (OIT).

The processor may be in communication with a non-transitory storage medium having computer-executable instructions stored thereon and the processor may be configured to execute the instruction and cause the system to receive, through an operator interface terminal (OIT), heating input related to a set point temperature for water, heat a first quantity of water within the heated water distribution loop from a baseline temperature to the set point temperature, maintain the first quantity of water at the set point temperature for a period of time, preserve a second quantity of water within the cooled water distribution loop at the baseline temperature for the period of time, and cool, in response to a trigger, the first quantity of water from the set point temperature to the baseline temperature. The heating input may include a request for heated water at the set point temperature and/or a time limit. The trigger may be a notification that the period of time has reached a predetermined time limit and/or a user-selected time limit. The trigger may also be termination by the user via the OIT.

The processor may also be configured to receive, through an OIT, cooling input related to a baseline temperature, cool a first quantity of water in the cooled water distribution loop from an initial temperature to a baseline temperature, maintain the first quantity of water at the baseline temperature for a period of time, and cease maintenance of the first quantity of water in response to a trigger. The cooling input may comprise a request for cooled water at the baseline temperature and/or a time limit. The trigger may comprise a notification that the period of time has reached a predetermined time limit and/or a user-selected time limit. The trigger may also be termination by the user via the OIT.

The laboratory water in the cooled water distribution loop may maintained at about an ambient temperature, such as between about 15.5° C. (60° F.) to about 27° C. (80.6° F.), in some embodiments about 18° C. (64.4° F.) to about 25° C. (77° F.), and still in some embodiments 18° C. (64.4° F.) to about 22° C. (71.6° F.). The heated water distribution loop may be configured to heat and maintain the laboratory water therein to a temperature above ambient, such as between about 50° C. (122° F.) to about 60° C. (140° F.), in some embodiments about 53° C. (127.4° F.) to about 57° C. (134.6° F.), and later cool the heated laboratory water therein to a temperature about ambient temperature prior to returning the laboratory water to the storing tank or dispensing the laboratory water to a waste drain. These temperature ranges can apply to all embodiments of the inventions.

The heated water distribution loop may be operatively connected to a heat exchanger to heat and maintain the laboratory water therein. The system may include outlets connected to the cooled water distribution loop and the heated water distribution loop, which may include laboratory faucets, and faucets for mixing buffers and media. In some embodiments, the cooled water distribution loop returns the laboratory water to the laboratory water storage tank. Additionally, there are provided methods of generating laboratory water and distributing laboratory water at different temperatures, the method comprising the steps of: (A) treating potable water in laboratory water generation section to generate laboratory water; (B) transferring the laboratory water from the water generation section to a laboratory water storage tank of a laboratory water storage section; (C) distributing the laboratory water using a laboratory water distribution section comprising: (1) at least one cooled water distribution loop in fluid communication with the laboratory water storage tank, the cooled water distribution loop configured to receive the laboratory water from the storage tank and to distribute the laboratory water at a first temperature range through one or more outlets, and (2) at least one heated water distribution loop in fluid communication with the laboratory water storage tank, the heated water distribution loop configured to receive the laboratory water from the storage tank and to distribute the laboratory water at a second temperature range through one or more outlets, the second temperature range exceeding the first temperature range; and (D) recycling a quantity of water in the heated water distribution loop by returning same to the storage tank, wherein at least one processor is operatively coupled to one or more of the laboratory water generation section, the laboratory water storage section, and the laboratory water distribution section. The functions described may be controlled by an operator, a user, or a programmer. The systems used in the methods can contain two or more cooled water distribution loops and two or more heated distribution loops.

In some embodiments, the laboratory water generation section can include first and second cooled water distribution loops in fluid communication with the laboratory water storage tank. The laboratory water generation section can include a multimedia filter, a cartridge filter, a water softening medium, an activated carbon bed, a reverse osmosis unit, a UV light, an ion exchange bed vessel and a mixed bed ion exchange vessel. In some embodiments, the laboratory water generation section is configured to generate reverse osmosis de-ionized (RODI) water, the cooled water distribution loop is configured to distribute cooled reverse osmosis de-ionized (CRODI) water, and the heated water distribution loop is configured to distribute heated reverse osmosis de-ionized (HRODI) water. In some embodiments, the cooled water distribution loop and/or the heated water distribution loop are operatively coupled to the storage tank via one or more valves. The laboratory water in the cooled and heated distribution loops may be controlled by an Operator Interface Terminal (OIT).

In some embodiments, the processor may be configured to execute the steps of: receiving cooling input related to a baseline temperature; cooling a first quantity of water in the cooled water distribution loop from an initial temperature to a baseline temperature; maintaining the first quantity of water at the baseline temperature for a period of time; and ceasing maintenance of the first quantity of water in response to a trigger. The cooling input may include a request for cooled water at the baseline temperature and/or a time limit. The trigger may be a notification that the period of time has reached a predetermined time limit and/or a user-selected time limit. The trigger may also be a termination by the user via the OIT.

The laboratory water in the cooled water distribution loop may maintained at about an ambient temperature, such as between about 15.5° C. (60° F.) to about 27° C. (80.6° F.), in some embodiments about 18° C. (64.4° F.) to about 25° C. (77° F.), and still in some embodiments 18° C. (64.4° F.) to about 22° C. (71.6° F.). The heated water distribution loop may be configured to heat and maintain the laboratory water therein to a temperature above ambient, such as between about 50° C. (122° F.) to about 60° C. (140° F.), in some embodiments about 53° C. (127.4° F.) to about 57° C. (134.6° F.), and later cool the heated laboratory water therein to a temperature about ambient temperature prior to returning the laboratory water to the storing tank or dispensing the laboratory water to a waste drain. These temperature ranges can apply to all embodiments of the inventions. In some embodiments, one or more cooled water distribution outlets may be connected to the cooled water distribution loop, which may include laboratory faucets. In some embodiments, one or more heated water distribution outlets may be connected to the heated water distribution loop, which may include laboratory faucets for mixing buffers or media. In some embodiments, laboratory water from the heated and/or cooled water distribution loops is recycled by returning same to the laboratory water storage tank.

### BRIEF DESCRIPTION OF THE FIGURES

Each accompanying Figure (Fig.), which are incorporated in and form a part of the specification, illustrate the embodiments of the inventions and together with the written description serve to explain the principles, characteristics, and features of the inventions.

FIG. 1A depicts an exemplary laboratory water distribution loop system in accordance with one or more embodiments.

FIG. 1B depicts a detailed view of a chiller of the main water distribution loop system in accordance with one or more embodiments.

FIG. 1C depicts a detailed view of a heat exchanger of the water distribution loop system in accordance with one or more embodiments.

FIG. 2 depicts a flow diagram of an illustrative computer-implemented method of regulating water temperature within sub distribution loop of a water distribution system in accordance with one or more embodiments.

FIG. 3 depicts a flow diagram of an illustrative computer-implemented method of regulating water temperature within a main distribution loop of a water distribution system in accordance with one or more embodiments.

FIG. 4 depicts a flow diagram of an illustrative computer-implemented method for regulating flow in a main distribution loop and a sub distribution loop of a water distribution system in accordance with one or more embodiments.

FIG. 5 depicts an exemplary laboratory water distribution loop system having a CRODI water distribution loop and a HRODI water distribution loop in accordance with one or more embodiments.

FIG. 6 depicts an exemplary laboratory water distribution loop system having first and second CRODI water distribution loops and a HRODI water distribution loop in accordance with one or more embodiments.

FIG. 7 depicts a flow diagram of an illustrative computer-implemented method of regulating water temperature within a HRODI water distribution loop of a water distribution system in accordance with one or more embodiments.

FIG. 8 depicts a flow diagram of an illustrative computer-implemented method of regulating water temperature within one or more CRODI water distribution loops of a water distribution system in accordance with one or more embodiments.

FIG. 9 depicts a block diagram of an exemplary data processing system in which one or more embodiments are implemented.

### DETAILED DESCRIPTION OF THE INVENTIONS

This disclosure is not limited to the particular systems, devices and methods described, as these may vary. The terminology used in the description is for the purpose of describing the particular versions or embodiments only, and is not intended to limit the scope. Such aspects of the disclosure may be embodied in many different forms; rather, these embodiments are provided so that this disclosure will be thorough and complete, and will fully convey its scope to those skilled in the art.

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. All numerical limits and ranges set forth herein include all numbers or values therebetween of the numbers of the range or limit. The ranges and limits disclosed herein expressly denominate and set forth all integers, decimals and fractional values defined by the range or limit. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells as well as the range of values greater than or equal to 1 cell and less than or equal to 3 cells. Similarly, a group having 1-5 cells refers to groups having 1, 2, 3, 4, or 5 cells, as well as the range of values greater than or equal to 1 cell and less than or equal to 5 cells, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera).

In addition, where features of the disclosure are described in terms of Markush groups, those skilled in the art will recognize that the disclosure is also thereby described in terms of any individual member or subgroup of members of the Markush group.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. The term “about” in the context of numerical values and ranges refers to values or ranges that approximate or are close to the recited values or ranges such that the inventions can perform as intended, such as having a desired rate, amount, degree, increase, decrease, or extent, as is apparent from the teachings contained herein. Thus, this term encompasses values beyond those simply resulting from systematic error.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera).

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, structures, or groups thereof, or any members of a claimed group, less than the full measure of this disclosure can be claimed for any reason.

Unless defined otherwise, all technical and scientific terms used herein have the same meanings as commonly understood by one of ordinary skill in the art, including scientists, engineers, researchers, industrial designers, laboratory and production technicians and assistants and users of the systems and methods for their designed purposes.

The present inventions provide systems and methods of generating laboratory water and distributing the laboratory water at various temperatures suitable for a given purpose. “Laboratory water” refers to water of an acceptable purity, quality and consistency for laboratory use and use for biologics production, such cell fermentation, on both an experimental and industrial scale. Reverse osmosis de-ionized water, or “RODI” water may be used interchangeably with laboratory water.

Protein-based therapeutics include, but are not limited to, the production of biological and pharmaceutical products. Protein-based therapeutics can have any amino acid sequence, and include any protein, polypeptide, or peptide that is desired to be manufactured. Included are, but not limited to, viral proteins, bacterial proteins, fungal proteins, plant proteins and animal (including human) proteins. Protein types can include, but are not limited to, antibodies, receptors, Fc-containing proteins, trap proteins, enzymes, factors, repressors, activators, ligands, reporter proteins, selection proteins, protein hormones, protein toxins, structural proteins, storage proteins, transport proteins, neurotransmitters and contractile proteins. Derivatives, components, chains and fragments of the above also are included. The sequences can be natural, semi-synthetic or synthetic.

Nucleic acid and nuclease therapeutics, such as RNAi, siRNA and CRISPER/Cas9, also are biologic therapeutics. Cemdisiran, a C5 siRNA therapeutic; ALN-APP, an RNAi for early onset Alzheimer's disease; an RNAi for nonalcoholic steatohepatitis and CRISPR/Cas9 for transthyretin amyloidosis are included.

For example, for antibody production , the inventions are amendable for research and production use for diagnostics and therapeutics based upon all major antibody classes, namely IgG, IgA, IgM, IgD and IgE. IgG is a preferred class, such as IgG1 (including IgG1λ and IgG1κ), IgG2, IgG3, IgG4 and others. Further antibody embodiments include a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. In one embodiment, the antibody is an IgG1 antibody. In one embodiment, the antibody is an IgG2 antibody. In one embodiment, the antibody is an IgG4 antibody. In one embodiment, the antibody is a chimeric IgG2/IgG4 antibody. In one embodiment, the antibody is a chimeric IgG2/IgG1 antibody. In one embodiment, the antibody is a chimeric IgG2/IgG1/IgG4 antibody. Derivatives, components, domains, chains and fragments of the above also are included. Further antibody embodiments include a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. In one embodiment, the antibody is an IgG1 antibody. In one embodiment, the antibody is an IgG2 antibody. In one embodiment, the antibody is an IgG4 antibody. In one embodiment, the antibody is a chimeric IgG2/IgG4 antibody. In one embodiment, the antibody is a chimeric IgG2/IgG1 antibody. In one embodiment, the antibody is a chimeric IgG2/IgG1/IgG4 antibody.

In additional embodiments, the antibody is selected from the group consisting of an anti-Programmed Cell Death 1 antibody (for example, an anti-PD1 antibody as described in U.S. Pat. Appln. Pub. No. US2015/0203579A1), an anti-Programmed Cell Death Ligand-1 (for example, an anti-PD-L1 antibody as described in in U.S. Pat. Appln. Pub. No. US2015/0203580A1), an anti-D114 antibody, an anti-Angiopoetin-2 antibody (for example, an anti-ANG2 antibody as described in U.S. Pat. No. 9,402,898), an anti-Angiopoetin-Like 3 antibody (for example, an antiAngPt13 antibody as described in U.S. Pat. No. 9,018,356), an anti-platelet derived growth factor receptor antibody (for example, an anti-PDGFR antibody as described in U.S. Pat. No. 9,265,827), an anti-Erb3 antibody, an anti-Prolactin Receptor antibody (for example, anti-PRLR antibody as described in U.S. Pat. No. 9,302,015), an anti-Complement 5 antibody (for example, an 25 anti-C5 antibody as described in U.S. Pat. Appln. Pub. No US2015/0313194A1), an anti-TNF antibody, an anti-epidermal growth factor receptor antibody (for example, an anti-EGFR antibody as described in U.S. Pat. No. 9,132,192 or an anti-EGFRvIII antibody as described in U.S. Pat. Appln. Pub. No. US2015/0259423A1), an anti-Proprotein Convertase Subtilisin Kexin-9 antibody (for example, an anti-PCSK9 antibody as described in U.S. Pat. No. 8,062,640 or U.S. Pat. Appln. Pub. No. US2014/0044730A1), an anti-Growth And Differentiation Factor-8 antibody (for example, an anti-GDF8 antibody, also known as anti-myostatin antibody, as described in U.S. Pat. Nos. 8,871,209 or 9,260,515), an anti-Glucagon Receptor (for example, anti-GCGR antibody as described in U.S. Pat. Appln. Pub. Nos. US2015/0337045A1 or US2016/0075778A1), an anti-VEGF antibody, an anti-IL1R antibody, an interleukin 4 receptor antibody (e.g an antiIL4R antibody as described in U.S. Pat. Appln. Pub. No. US2014/0271681A1 or U.S. Pat Nos. 8,735,095 or 8,945,559), an anti-interleukin 6 receptor antibody (for example, an anti-IL6R antibody as described in U.S. Pat. Nos. 7,582,298, 8,043,617 or 9,173,880), an anti-IL1 antibody, an anti-IL2 antibody, an anti-IL3 antibody, an anti-IL4 antibody, an anti-IL5 antibody, an anti-IL6 antibody, an anti-IL7 antibody, an anti-interleukin 33 (for example, anti-IL33 antibody as described in U.S. Pat. Appln. Pub. Nos. US2014/0271658A1 or US2014/0271642A1), an anti-Respiratory syncytial virus antibody (for example, anti-RSV antibody as described in U.S. Pat. Appln. Pub. No. US2014/0271653A1), an anti-Cluster of differentiation 3 (for example, an anti-CD3 antibody, as described in U.S. Pat. Appln. Pub. Nos. US2014/0088295A1 and US20150266966A1, and in U.S. Application No. 62/222,605), an anti-Cluster of differentiation 20 (for example, an anti-CD20 antibody as described in U.S. Pat. Appln. Pub. Nos. US2014/0088295A1 and US20150266966A1, and in U.S. Pat. No. 7,879,984), an anti-CD19 antibody, an anti-CD28 antibody, an anti-Cluster of Differentiation 48 (for example, anti-CD48 antibody as described in U.S. Pat. No. 9,228,014), an anti-Fel d1 antibody (for example, as described in U.S. Pat. No. 9,079,948), an anti-Middle East Respiratory Syndrome virus (for example, an anti-MERS antibody as described in U.S. Pat. Appln. Pub. No. US2015/0337029A1), an anti-Ebola virus antibody (for example, as described in U.S. Pat. Appln. Pub. No. US2016/0215040), an anti-Zika virus antibody, an anti-Lymphocyte Activation Gene 3 antibody (for example, an anti-LAG3 antibody, or an anti-CD223 antibody), an anti-Nerve Growth Factor antibody (for example, an anti-NGF antibody as described in U.S. Pat. Appln. Pub. No. US2016/0017029 and U.S. Pat. Nos. 8,309,088 and 9,353,176) and an anti-Activin A antibody. In some embodiments, the bispecific antibody is selected from the group consisting of an anti-CD3× anti-CD20 bispecific antibody (as described in U.S. Pat. Appln. Pub. Nos. US2014/0088295A1 and US20150266966A1), an anti-CD3× anti-Mucin 16 bispecific antibody (for example, an anti-CD3 x anti-Muc16 bispecific antibody), and an anti-CD3× anti-Prostate-specific membrane antigen bispecific antibody (for example, an anti-CD3× anti-PSMA bispecific antibody). See also U.S. Patent Publication No. US 2019/0285580 A1. Also included are a Met×Met antibody, an agonist antibody to NPR1, an LEPR agonist antibody, a BCMA×CD3 antibody, a MUC16×CD28 antibody, a GITR antibody, an IL-2Rg antibody, an EGFR×CD28 antibody, a Factor XI antibody, antibodies against SARS-CoC-2 variants, a Fel d1 multi-antibody therapy, a Bet v 1 multi-antibody therapy. Derivatives, components, domains, chains and fragments of the above also are included.

Exemplary antibodies to be produced according to the inventions include Alirocumab, Atoltivimab, Maftivimab, Odesivimab, Odesivivmab-ebgn, Casirivimab, Imdevimab, Cemiplimab, Cemplimab-rwlc, Dupilumab, Evinacumab, Evinacumab-dgnb, Fasinumab, Fianlimab, Garetosmab, Itepekimab Nesvacumab, Odrononextamab, Pozelimab, Sarilumab, Trevogrumab, and Rinucumab,

Additional exemplary antibodies include Ravulizumab-cwvz, Abciximab, Adalimumab, Adalimumab-atto, Ado-trastuzumab, Alemtuzumab, Atezolizumab, Avelumab, Basiliximab, Belimumab, Benralizumab, Bevacizumab, Bezlotoxumab, Blinatumomab, Brentuximab vedotin, Brodalumab, Canakinumab, Capromab pendetide, Certolizumab pegol, Cetuximab, Denosumab, Dinutuximab, Durvalumab, Eculizumab, Elotuzumab, Emicizumab-kxwh, Emtansine alirocumab, Evolocumab, Golimumab, Guselkumab, Ibritumomab tiuxetan, Idarucizumab, Infliximab, Infliximab-abda, Infliximab-dyyb, Ipilimumab, Ixekizumab, Mepolizumab, Necitumumab, Nivolumab, Obiltoxaximab, Obinutuzumab, Ocrelizumab, Ofatumumab, Olaratumab, Omalizumab, Panitumumab, Pembrolizumab, Pertuzumab, Ramucirumab, Ranibizumab, Raxibacumab, Reslizumab, Rinucumab, Rituximab, Secukinumab, Siltuximab, Tocilizumab, Trastuzumab, Ustekinumab, and Vedolizumab

The inventions also are amenable to the production of other molecules, including fusion proteins. Preferred fusion proteins include Receptor-Fc-fusion proteins, such as certain Trap proteins. The protein of interest can be a recombinant protein that contains an Fc moiety and another domain, (for example, an Fc-fusion protein). In some embodiments, an Fc-fusion protein is a receptor Fc-fusion protein, which contains one or more extracellular domain(s) of a receptor coupled to an Fc moiety. In some embodiments, the Fc moiety comprises a hinge region followed by a CH2 and CH3 domain of an IgG. In some embodiments, the receptor Fc-fusion protein contains two or more distinct receptor chains that bind to either a single ligand or multiple ligands. For example, an Fc-fusion protein is a TRAP protein, such as for example an IL-1 trap (for example, rilonacept, which contains the IL-1RAcP ligand binding region fused to the II-1R1 extracellular region fused to Fc of hIgG1; see U.S. Pat. No. 6,927,044, or a VEGF trap (for example, aflibercept or ziv-aflibercept, which contains the Ig domain 2 of the VEGF receptor Flt1 fused to the Ig domain 3 of the VEGF receptor Flk1 fused to Fc of hIgG1; see U.S. Pat. Nos. 7,087,411 and 7,279,159). In other embodiments, an Fc-fusion protein is a ScFv-Fc-fusion protein, which contains one or more of one or more antigen binding domain(s), such as a variable heavy chain fragment and a variable light chain fragment, of an antibody coupled to an Fc moiety. Derivatives, components, domains, chains and fragments of the above also are included.

Other proteins lacking Fc portions, such as recombinantly produced enzymes and mini-traps, also can be made according to the inventions. Mini-traps are trap proteins that use a multimerizing component (MC) instead of an Fc portion, and are disclosed in U.S. Pat. Nos. 7,279,159 and 7,087,411. Derivatives, components, domains, chains and fragments of the above also are included.

The inventions also are applicable to production of biosimilar products. Biosimilar products, often referred to as follow on products, are defined in various ways depending on the jurisdiction, but share a common feature of comparison to a previously approved biological product in that jurisdiction, usually referred to as a “reference product.” According to the World Health Organization, a biosimilar product (‘biosimilar’) is currently a biotherapeutic product similar to an already licensed reference biotherapeutic product in terms of quality, safety and efficacy, and currently is followed in many countries, such as the Philippines.

A biosimilar in the U.S. is currently described as (A) a biological product is highly similar to the reference product notwithstanding minor differences in clinically inactive components; and (B) there are no clinically meaningful differences between the biological product and the reference product in terms of the safety, purity, and potency of the product. In the U.S., an interchangeable biosimilar or product that is shown that may be substituted for the previous product without the intervention of the health care provider who prescribed the previous product. In the European Union, a biosimilar is currently a biological medicine highly similar to another biological medicine already approved in the EU (called “reference medicine”) in terms of structure, biological activity and efficacy, safety and immunogenicity profile (the intrinsic ability of proteins and other biological medicines to cause an immune response), and these guidelines are followed by Russia. In China, a biosimilar currently refers to biologics that contain active substances similar to the original biologic drug and is similar to the original biologic drug in terms of quality, safety, and effectiveness, with no clinically significant differences. In Japan, a biosimilar currently is a product that has bioequivalent/quality-equivalent quality, safety, and efficacy to an reference product already approved in Japan. In India, biosimilars are currently referred to as “similar biologics,” and refer to a similar biologic product is that which is similar in terms of quality, safety, and efficacy to an approved reference biological product based on comparability. In Australia, a biosimilar medicine currently is a highly similar version of a reference biological medicine. In Mexico, Columbia, and Brazil, a biosimilar currently is a biotherapeutic product that is similar in terms of quality, safety, and efficacy to an already licensed reference product. In Argentina, biosimilar currently is derived from an original product (a comparator) with which it has common features. In Singapore, a biosimilar currently is a biological therapeutic product that is similar to an existing biological product registered in Singapore in terms of physicochemical characteristics, biological activity, safety and efficacy. In Malaysia, a biosimilar currently is a new biological medicinal product developed to be similar in terms of quality, safety and efficacy to an already registered, well established medicinal product. In Canada, a biosimilar currently is a biologic drug that is highly similar to a biologic drug that was already authorized for sale. In South Africa, a biosimilar currently is a biological medicine developed to be similar to a biological medicine already approved for human use. Biosimilars and its synonyms under these and any revised definitions are within the scope of the inventions.

The inventions can also be employed in the production of recombinantly-produced proteins, such as viral proteins (for example, adenovirus and adeno-associated virus (AAV) proteins), bacterial proteins and eukaryotic proteins. Additionally, the inventions can be employed in the production of viruses and viral vectors, for example parvovirus, dependovirus, lentivirus, herpesvirus, adenovirus, AAV, and poxvirus.

### EXAMPLES

The following examples describe operation parameters of embodiments according to the inventions, and does not limit the scope of the inventions in any manner.

The laboratory water generation and distribution systems can continuously and consistently generate water for laboratory and production uses and washing. The functions of the system can be controlled through a PLC. Typically, point-of-use (POU) valves are manual or pneumatically operated. Automated POU valves with PLCs can be used for autoclave and glasswasher, and can communicate with the PLC of the RODI loops. PLCs are provided with connectivity to allow for new control systems and are capable of preventing out-of-specification water from being distributed.

The loops can operate in a recirculating mode with the laboratory water around 68° F. Temperature can utilize PID control loop to ensure that he laboratory water is at the selected temperature. If the temperature exceeds the selected temperature [for example, 77° F.], an alert can be set off. Additionally, the laboratory water in the main loop can be monitored for conductivity [for example, <1.0 μS/cm] and Total Organic Carbon (TOC) [for example, <50 ppb]. For example, an alert value at 80% of ASTM Type II quality requirements can be set off when RODI exceeds a preset conductivity or TOC.

Distribution pressure can be controlled by the back-pressure control valve on a PID loop with the return line pressure transmitter. The back-pressure control valve can control pressure and provide an alert if the loop pressure exceeds or fall a preset pressure.

It should be understood that particularly in biologics production processes, a high degree of specificity is required when preparing materials. Various production processes may be extremely sensitive to the temperature of water and other materials utilizes and the processes may additionally be time sensitive. Accordingly, while conventional practices may entail drawing water from a common source and heating or cooling as necessary, the typical apparatuses may not be equipped with sensors and/or feedback systems to allow for fine control of temperature in the manner required. Furthermore, time sensitive production processes involving several steps may not tolerate the delays associated with conventional methods of preparing temperature-specific laboratory water. Accordingly, the systems disclosed herein advantageously overcome the issues with conventional systems and methods by providing a precise temperature-controlled water source that may be pre-set, maintained, and made available on demand. Furthermore, unused temperature-controlled water is cooled and recycled such that waste of purified water is minimized by the systems and methods herein.

### Laboratory Water Distribution Loop System 100

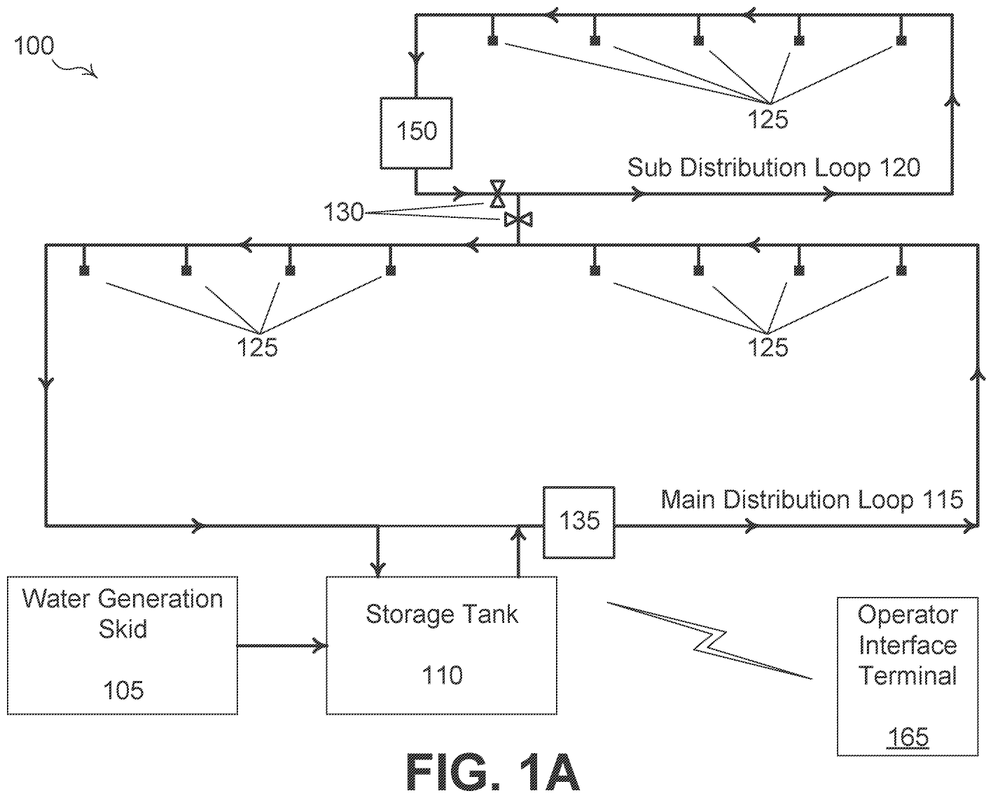

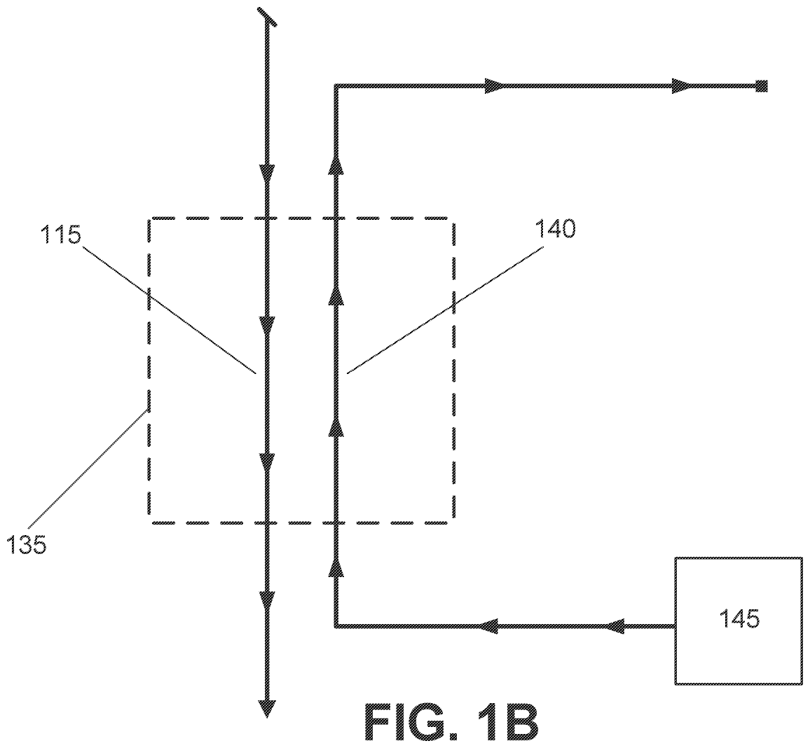

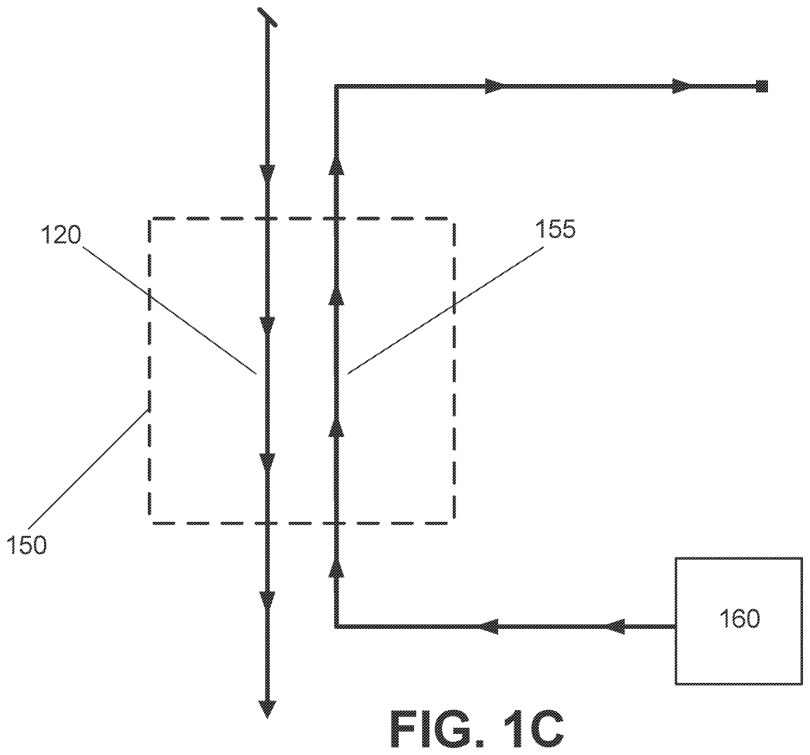

Referring now to FIGS. 1A-1C, an exemplary laboratory water distribution loop system is depicted in accordance with an embodiment. As shown in FIG. 1A, the laboratory water distribution loop system 100 comprises a laboratory water generation skid 105, a storage tank 110 in fluid communication with the laboratory water generation skid 105, a main distribution loop 115 in fluid communication with the storage tank 110, and a sub distribution loop 120 extending from the main distribution loop 115 and in fluid communication therewith in a chase-the-tail configuration, wherein the sub distribution loop 120 feeds back to the main distribution loop 115, or as an alternative directly back to the storage tank. The system further comprises one or more outlets 125, each outlet 125 connected to one of the main distribution loop 115 and the sub distribution loop 120 for dispensing water therefrom. The main distribution loop 115 and the sub distribution loop 120 may be selectively in communication by one or more valves 130 (for example, 130A). In some embodiments, the main distribution loop 115 comprises a heat exchanger or chiller 135 configured to maintain the laboratory water at a baseline temperature. In some embodiments, the sub distribution loop 120 comprises a heat exchanger 150 configured to raise the temperature of the laboratory water received from the main distribution loop 115 to a set point temperature and maintain the water at the set point temperature. The system 100 further comprises one or more interface units, or operator interface terminals (OITs) 165, for a user or operator to interface with the system 100, including receiving information and/or providing input for control thereof.

### Water Generation Skid

The water generation skid 105 may include a water source for receiving potable water or other water that may be processed into laboratory water. Various processing steps may be used to generate laboratory water that preferably meets the standards of ASTM Type II. For example, the potable water may be filtered by various media, softened, de-chlorinated, deionized, distilled, and/or sterilized by the water generation skid 105. Accordingly, the water generation skid 105 may include various processing components.

In some embodiments, the water generation skid 105 comprises a multimedia filter stage to remove particulate matter from the water. In some embodiments, the multimedia filter may be configured to remove particulates having a size or diameter of 10 μm or greater. In some embodiments, the multimedia filter may be configure to remove particulates having a size or diameter of 5 μm or greater. The multimedia filter may include a plurality of stages or layers in order to gradually remove particulates of progressively smaller sizes. For example, the multimedia filter may include one or more gravel layers, one or more garnet layers, one or more anthracite layers, one or more coarse sand layers, one or more fine sand layers, and/or combinations thereof. In some embodiments, the media layers may be pre-backwashed and drained. In some embodiments, each media layer may be arranged and selected for specific gravity in a manner to allow self-contained re-stratification after backwashing. For example, the media layers may be arranged by specific gravity in ascending order from top to bottom.

In some embodiments, the water generation skid 105 comprises a water softener stage configured to remove hardness ions from the water. In some embodiments, the water softener is configured to remove calcium ions (Ca²⁺), magnesium ions (Mg²⁺), and/or other metal ions from the water. In some embodiments, the water softener is configured to remove calcium and magnesium ions through ion exchange. For example, the water may be passed through a filter bed comprising resin beads (for example, beads containing NaCO₂ particles), whereby Ca²⁺ and Mg²⁺ cations bind to the beads (for example, to the COO⁻ anions) and release sodium cations (Na⁺) into the water. In some embodiments, the water generation skid 105 may further comprise a brine tank and eductor in communication with the water softener and configured to regenerate the water softener, for example, to maintain a level of NaCO₂ particles to continually remove Ca²⁺ and Mg²⁺ cations from the water supply. In additional embodiments, the water softener may be configured to treat the water with slaked lime, for example, Ca(OH)₂, and soda ash, for example, Na₂CO₃, in order to precipitate calcium as CaCO₃ and magnesium as Mg(OH)₂.

In some embodiments, the water generation skid 105 comprises a carbon bed filter stage. In some embodiments, the carbon bed filter is configured to remove chlorine and other trace organic compounds from the water. In some embodiments, the carbon bed filter is configured to break chloramines in the water (for example, NH₂Cl, NHCl₂, NCl₃) into chlorine, ammonia, and/or ammonium.

In some embodiments, the water generation skid 105 comprises one or more mixed deionization (DI) beds configured to remove dissolved ammonia, CO₂, and/or trace charged compounds and elements.

In some embodiments, the water generation skid 105 comprises additional types of ion exchange beds for removing organic compounds as would be apparent to a person having an ordinary level of art. The ion exchange beds may include resin beads of varying sizes and properties in order to remove different types of particles. For example, the ion exchange beds may include strong acid cation exchange resins, weak acid cation exchange resins, strong base anion exchange resins, weak base anion exchange resins, and/or chelating resins.

In some embodiments, the water generation skid 105 comprises a reverse osmosis filtration stage configured to remove trace compounds, ammonium, carbon fines and/or other particulate matter, microorganisms, and/or endotoxins from the water. For example, the reverse osmosis stage may include a semi-permeable membrane and a pump configured to apply a pressure greater than an osmotic pressure in the water to cause diffusion of the water through the membrane. Because the efficacy of reverse osmosis is dependent on pressure, solute concentration, and other conditions, the reverse osmosis filtration stage may include one or more sensors configured to monitor conditions within the reverse osmosis unit. For example, the reverse osmosis filtration stage may include an inlet conductivity monitor, a permeate conductivity monitor, a concentrate flow meter, a permeate flow meter, a suction pressure indicator, a high pressure kill switch, and/or an instrument air pressure switch.

In some embodiments, the water generation skid 105 comprises an ultraviolet (UV) light stage configured to inactivate microbes in the water. For example, the water generation skid 105 may include one or more UV light sources configured to emit UV light at a wavelength of 185 nm, 254 nm, 265 nm, and/or additional wavelengths configured to inactivate microbes. In some embodiments, the UV light sources may include quartz lamp sleeves thereon to insulate the UV light sources from temperature changes. In some embodiments, the UV light stage is configured to emit light at a dosage in microwatt seconds per square centimeter (μW-s/cm²) capable of inactivating microbes across the entire volume of water within the UV light stage. The dosage of light emitted within the UV light stage may be based on the internal volume, the light intensity of the one or more UV light sources, and the flow rate of water through the UV light stage. In some embodiments, the UV light stage may include an internal baffle (for example, a helical baffle or static blender) in order to facilitate thorough mixing of water through the UV light stage, thereby causing greater exposure of the water to UV light.

In some embodiments, the water generation skid 105 comprises one or more filter cartridges for removing contaminants from the potable water. For example, one or more of the various stages of the water generation skid 105 as described herein may be provided in the form of a cartridge.

In some embodiments, the water generation skid 105 comprises additional components as would be apparent to a person having an ordinary level of skill in the art to control, maintain, and regulate flow of water through the various stages and process the water in the manners described herein. For example, the water generation skid 105 may include distribution pumps, booster pumps, centrifugal pumps, transmitters, valves, power sources, sensors, and electrical circuitry as would be required to process the water and maintain adequate conditions in the various stages of the water generation skid 105.

### Water Storage Tank

Referring again to FIG. 1A, the water generation skid 105 is in fluid communication with a storage tank 110 configured to receive laboratory water from the water generation skid 105 and store the water therein. In some embodiments, the storage tank 110 is configured to maintain the quality of the laboratory water after processing by the water generation skid 105. Furthermore, the storage tank 110 may be configured to distribute the water to the distribution loop as further described herein. The storage tank also may be in fluid communication with piping and outlets that are not part of the main and sub distribution loops. In some embodiments, the storage tank may comprise one or more valves for selectively permitting fluid to pass out of the storage tank 110 to the main and sub distribution loops.

In some embodiments, the laboratory water received by the storage tank 110 from the water generation skid 105 may be elevated in temperature. For example, the various filtration and processing steps as described herein may result in the laboratory water having an elevated temperature. Accordingly, the water in the storage tank 110 may passively cool down to ambient temperature over time and/or be actively cooled using a chiller when entering the main distribution loop 115 as further described herein. In some embodiments, the storage tank 110 may include a chiller to actively cool the laboratory water.

### Main and Sub Distribution Loops

Referring once again to FIG. 1A, the main distribution loop 115 is in fluid communication with the storage tank 110 at a first end. The main distribution loop 115 may be configured to receive laboratory water from the storage tank 110 at the first end and circulate the water through the main distribution loop 115. In some embodiments, the main distribution loop 115 is additionally in fluid communication with the storage tank 110 at a second end. The main distribution loop 115 may be configured to return laboratory water to the storage tank 110 at the second end after circulation of the water through the main distribution loop 115.

In some embodiments, the main distribution loop 115 is configured to maintain the laboratory water therein at a baseline temperature. For example, the baseline temperature may be about room temperature. In another example, the baseline temperature may be about 18° C. to about 25° C. In a further example, the baseline temperature may be below room temperature, for example, about 18° C. to about 22° C.

In some embodiments, the main distribution loop 115 comprises a heat exchanger or chiller 135 configured to maintain the laboratory water at the baseline temperature. For example, the chiller 135 may circulate a fluid therethrough in proximity to the main distribution loop 115 to chill the laboratory water as need to maintain the baseline temperature. The fluid in the chiller 135 may be chilled glycol (for example, propylene glycol), chilled water, or another fluid capable of transferring heat out of the laboratory water. It should be understood that no fluid is exchanged between the chiller 135 and the main distribution loop 115. Rather, the fluids of the chiller 135 and the main distribution loop 115 exchange heat through one or more interfacing surfaces therebetween without any direct contact and/or transfer.

In some embodiments, the laboratory water stored in the storage tank 110 may passively cool and maintain at or near the baseline temperature, for example, 25° C. Accordingly, the chiller 135 may not be constantly running. In some embodiments, the chiller 135 is activated when a large batch of laboratory water is generated in order to cool the fresh laboratory water to the baseline temperature. In some embodiments, the main distribution loop 115 is configured to maintain the laboratory water at a temperature different than the temperature of water in the storage tank 110.

Referring now to FIG. 1B, a detailed view of the chiller 135 is depicted in accordance with an embodiment. As shown, the chiller 135 may include one or more conduits 140 extending therethrough in fluid communication with a source 145 of cooling fluid, for example, chilled glycol, chilled water or another coolant as would be apparent to a person having an ordinary level of skill in the art. A portion of the main distribution loop 115 may pass through the chiller 135 in proximity to the conduit 140 such that the water in the main distribution loop 115 is chilled by heat transfer with the cooling fluid circulating through the conduit 140. In some embodiments, the main distribution loop 115 and the conduit 140 may share an interface surface therebetween for heat transfer. In some embodiments, the conduit 140 may pass the cooling fluid to an air separator and/or a recharging unit for recharging the cooling fluid. Thereafter, the cooling fluid may circulate back to the source 145 to be reused. In some embodiments, the conduit 140 may pass the cooling fluid to a disposal site. In some embodiments, the chiller 135 may be configured as a closed recirculating system. In some embodiments, the chiller 135 may be configured as an open recirculating system.

The chiller 135 may include additional components for controlling movement and/or monitoring the fluid. For example, the chiller 135 may include one or more pumps, valves (for example, two-way valves), power sources, sensors, and/or electrical circuitry.

In some embodiments, a plurality of chillers 135 may be operably connected to the main distribution loop 115 in order to provide more consistent and/or more accurate temperature control. Furthermore, while the chiller 135 is depicted proximate to a starting portion of the main distribution loop 115, it should be understood that the chiller 135 may interface with the main distribution loop 115 at any point along the loop.

In some embodiments, the chiller 135 may include a compressor, an evaporator, and/or a condenser. Additional manners of maintaining the temperature in the distribution loop are contemplated as would be apparent to a person having an ordinary level of skill in the art.

In some embodiments, the sub distribution loop 120 is in fluid communication with the main distribution loop 115 at a first end of the sub distribution loop. The sub distribution loop 120 may be configured to receive laboratory water from the main distribution loop 115. In some embodiments, the sub distribution loop 120 is configured to maintain the laboratory water therein at a set point temperature different from the baseline temperature of the storage tank 110 and/or the main distribution loop 115. For example, where the laboratory water is maintained by the storage tank 110 and the main distribution loop 115 at about 18° C. to about 25° C., the sub distribution loop 120 may maintain the laboratory water between about 53° C. to about 57° C. In some embodiments, the set point temperature for the sub distribution loop 120 is variable and may be adjusted based on input from a user and/or parameters associated with a specific procedure.

In some embodiments, the sub distribution loop 120 comprises a heat exchanger 150 configured to raise the temperature of the laboratory water received from the main distribution loop 115 to the set point temperature and maintain the water at the set point temperature. For example, the heat exchanger 150 may circulate a heated fluid (for example, steam or hot water) therethrough in proximity to the sub distribution loop 120 to continuously heat the laboratory water and maintain the set point temperature, for example, about 57° C. In some embodiments, the heat exchanger 150 may include or may be in fluid communication with a boiler for receiving the heated fluid, for example, steam. It should be understood that no fluid is exchanged between the heat exchanger 150 and the sub distribution loop 120. Rather, the fluids of the heat exchanger 150 and the sub distribution loop 120 exchange heat through one or more interfacing surfaces therebetween without any direct contact and/or transfer.

Referring now to FIG. 1C, a detailed view of the heat exchanger 150 is depicted in accordance with an embodiment. As shown, the heat exchanger 150 may include one or more conduits 155 extending therethrough in fluid communication with a source 160 of heating fluid, for example, steam, hot water, or another heating fluid as would be apparent to a person having an ordinary level of skill in the art. A portion of the sub distribution loop 120 may pass through the heat exchanger 150 in proximity to the conduit 155 such that the water in the sub distribution loop 120 is heated by heat transfer with the heating fluid circulating through the conduit 155 to continuously heat the laboratory water and maintain the set point temperature, for example, about 57° C. In some embodiments, the sub distribution loop 120 and the conduit 155 may share an interface surface therebetween for heat transfer. In some embodiments, the conduit 155 may pass the heating fluid to a recharging unit for recharging the heating fluid. Thereafter, the heating fluid may circulate back to the source 160 to be reused. In some embodiments, the conduit 155 may pass the heating fluid to a disposal site. In some embodiments, the heat exchanger 150 may be configured as a closed recirculating system. In some embodiments, the heat exchanger 150 may be configured as an open recirculating system. Various types of heating units and configurations thereof may be implemented herein as would be known to a person having an ordinary level of skill in the art.

The heat exchanger 150 may include additional components for controlling movement and/or monitoring the heating fluid. For example, the heat exchanger 150 may include one or more pumps, valves (for example, two-way valves), power sources, sensors, and/or electrical circuitry.

In some embodiments, a plurality of heat exchangers 150 may be operably connected to the sub distribution loop 120 in order to provide more consistent and/or more accurate temperature control. Furthermore, while the heat exchanger 150 is depicted proximate to an end portion of the sub distribution loop 120, it should be understood that the heat exchanger 150 may interface with the sub distribution loop 120 at any point along the loop.

It should be understood that the elevated temperature in the sub distribution loop 120 is a selective feature which may be activated and deactivated. Accordingly, during certain time periods, the laboratory water in the sub distribution loop may be not be elevated. In some embodiments, the sub distribution loop 120 may have a baseline temperature substantially matching the main distribution loop 115 and/or storage tank 110. For example, the temperature of the laboratory water in the sub distribution loop 120 may be ambient and/or chilled as described herein.

In some embodiments, the sub distribution loop 120 may circulate the laboratory water back to the storage tank 110 in order to recycle the laboratory water that is not used at the set point temperature. In some embodiments, the water from the sub distribution loop 120 may be in fluid communication with the main distribution loop 115 at a second end of the sub distribution loop 120. For example, the second end of the sub distribution loop 120 may connect back to a channel interfacing with the main distribution loop 115 as further described herein. In another example, the second end of the sub distribution loop 120 may connect separately to the main distribution loop 115. Accordingly, the water from the sub distribution loop 120 may return to the main distribution loop 15 and eventually return to the storage tank 110 therethrough. In some embodiments, the sub distribution loop 120 may be in direct fluid communication with the storage tank 110 and may return water directly thereto. In some embodiments, the heat exchanger of the sub distribution loop 120 and/or an additional heat exchanger may cool the laboratory water within the sub distribution loop 120 back to the baseline temperature before dispensing to the main distribution loop 115 and/or the storage tank 110. In some embodiments, the heat exchanger of the main distribution loop 115 may chill the heated water received from the sub distribution loop 120 back to the baseline temperature. Additional manners of maintaining the temperature in the distribution loop are contemplated as would be apparent to a person having an ordinary level of skill in the art.

By recycling the heated laboratory water from the sub distribution loop 120 back to the main distribution loop 115 and/or the storage tank 110, the laboratory water is conserved and waste is minimized. Generally, production of highly purified laboratory water is expensive, time consuming, and energy intensive due to the equipment, consumables, and degree of precision required. Optionally, costs may be significantly reduced by recycling the heated laboratory water from the sub distribution loop 120 as described herein. By the systems and methods as described, immediate availability of the water and efficient use of the water may be simultaneously achieved.

In some embodiments, the main distribution loop 115 and the sub distribution loop 120 are selectively in communication via one or more valves 130. For example, as shown in FIG. 1A, a valve 130A may be positioned in the channel connecting the sub distribution loop 120 to the main distribution loop 115. Accordingly, after laboratory water is transferred from the main distribution loop 115 to the sub distribution loop 120, the laboratory water in the sub distribution loop 120 may be segregated from the main distribution loop 115 by shutting the valve 130A in order to maintain the water therein at the separate set point temperature. As shown, the water in the sub distribution loop 120 may circulate therein while the valve 130A is closed. As water is consumed, the valve 130A may be opened to replenish the water supply in the sub distribution loop. Furthermore, a second valve 130B may be located near the end of the sub distribution loop 120 it order to permit or prohibit flow therethrough. When the use of the water at the set point temperature is complete in a given instance, the valves 130A/130B may be opened to return the water to the main distribution loop 115.

The main and sub loop systems can be operated manually, manually and automated, and fully automated. For automated operation, computer processors and electrically controlled valves and heat exchangers can be employed. Provided herein are exemplary approaches for automated control using computer technology.

In some embodiments, the valves 130 are in electrical communication with a processor as further described herein and may be controlled by the processor via electrical signals. In some embodiments, the valves 130 are operably connected to an actuator to open and close the valves. In some embodiments, the valves 130 may be two-way valves. In some embodiments, the valves 130 may be zero-static tee valves. In some embodiments, the valves 130 may be solenoid valves. In some embodiments, the valves 130 may be operably connected servo motors to open and close the valves. Additional types of valves are contemplated herein as would be apparent to a person having an ordinary level of skill in the art.

As shown in FIG. 1A, the sub distribution loop 120 may form a complete loop in a “chase-the-tail” configuration to allow circulation within the sub distribution loop 120. In additional embodiments, ingress to the sub distribution loop 120 and egress from the sub distribution loop 120 may occur through separate connecting channels. Accordingly, each connecting channel may comprise a valve 130. In additional embodiments, a connecting channel may interface directly between the sub distribution loop 120 and the storage tank 110. Accordingly, the connecting channel may include a valve 130 in order to selectively return the water to the storage tank 110.

The main distribution loop 115 and the sub distribution loop 120 may further comprise one or more outlets 125 for dispensing the laboratory water therefrom. The outlets 125 may be provided across a variety of dedicated spaces within a facility. In some embodiments, the outlets 125 for each distribution loop 115/120 are intended for unique purposes. For example, while the chilled or ambient water in the main distribution loop 115 may be sufficient for washing, rinsing, and chemical and/or biotechnological processes. However, heated water at a precisely controlled temperature may be required for preparing media, preparing buffers, and the like.

In some embodiments, at least some of the outlets 125 may be manual outlets, for example, faucets, sinks, wall mounted water outlets, media/buffer outlets, and the like which are manually operable by a user. In some embodiments, at least some of the outlets 125 may be automatic outlets that connect the supply of laboratory water to appliances such as refrigerators, washing appliances for glassware and other laboratory supplies, incubators, and/or autoclave machines. It should be understood that any type of outlet 125 may be configured as manual or automatic according to function or preference.

In some embodiments, the main distribution loop 115 may comprise one or more pumps dedicated to circulating water within the main distribution loop 115. In some embodiments, the sub distribution loop 120 may comprise one or more pumps dedicated to circulating water within the sub distribution loop 120. For example, as shown in FIG. 1A, water may circulate within the sub distribution loop 120 while the valve 130A is closed and the valve 130B is open. Accordingly, the sub distribution loop 120 may have a dedicated pump such that water may be circulated even when segregated from the main distribution loop. In some embodiments, the one or more pumps of the sub distribution loop 120 are centrifugal pumps. However, additional types of pumps may be utilized herein as would be apparent to a person having an ordinary level of skill in the art.

The piping forming the main distribution loop 115, the sub distribution 120, the outlets 125, and/or additional piping in the system 100 may comprise carbon steel piping and fittings. In some embodiments, the piping may be insulated, for example, with fiberglass insulation and/or and a jacket in order to efficiently maintain temperatures of water within the piping. In some embodiments, the jacket may be a PVC jacket (for example, for indoor piping) or an aluminum jacket (for example, for outdoor piping).

In some embodiments, the distribution loops 115/120 may be operably connected to one or more exhaust fans configured to exhaust energy from the distribution system. For example, two exhaust fans may operate simultaneously to exhaust heat and maintain the conditions of the distribution system. In some embodiments, the exhaust fans may form an energy recovery unit comprising one or more coils and one or more strobic fans that may recycle exhausted energy (for example, heat) from the distribution system for heating air within a facility and other purposes.

Each of the distribution loops 115/120 may include an array of sensors and/or alarms configured to monitor one or more parameters in the laboratory water. For example, the array of sensors may be configured to monitor temperature, conductivity, total organic carbon, distribution pressure, and/or loop pressure. In some embodiments, a notification or alarm may sound wherein one or more parameters are approaching or outside of a desired range.

Each of the distribution loops 115/120 may be configured with sensors and electrical control components configure to regulate the laboratory water in a proportional-integral-derivative (PID) control loop. In the PID loop, the sensors may be used to continuously assess deviation from set parameters and the control device may implement corrections to restore the set parameters with minimal delay. For example, temperature sensors may be used to monitor temperature in a virtually continuous fashion and the heat exchange may be used to implement corrections as need to maintain the baseline temperature and/or set point temperature for each distribution loop.

It should be understood that any of the various valves described herein with respect to components of the system 100 may comprise any type of valve that would be known to a person having an ordinary level of skill in the art. For example, the valves may comprise two-way valves, zero-static tee valves, solenoid valves, servo motor-controlled valves, and the like.

In some embodiments, any of the disclosed features or components may be redundantly provided for any of the purposes described herein may be utilized to achieve more consistent conditions and/or reduce a probability of failure. For example, heat exchangers, fans, distribution pumps, sensors, and the like may be provided in duplicate or triplicate for any of the purposes described herein.

It should be understood that particularly in viral production processes, a high degree of specificity is required when preparing materials. Various production processes may be extremely sensitive to the temperature of water and other materials utilizes and the processes may additionally be time sensitive. Accordingly, while conventional practices may entail drawing water from a common source and heating or cooling as necessary, the typical apparatuses may not be equipped with sensors and/or feedback systems to allow for fine control of temperature in the manner required. Furthermore, time sensitive production processes involving several steps may not tolerate the delays associated with conventional methods of preparing temperature-specific laboratory water. Accordingly, the systems disclosed herein advantageously overcome the issues with conventional systems and methods by providing a precise temperature-controlled water source that may be pre-set, maintained, and made available on demand. Furthermore, unused temperature-controlled water is cooled and recycled such that waste of purified water is minimized by the systems and methods herein.

### Control Systems and Methods

The laboratory water distribution loop system 100 as described herein may be controlled via a process control system. In some embodiments, the process control system comprises one or more processors and a non-transitory, computer-readable medium storing instructions executable by the one or more processors. In some embodiments, the process control system comprises one or more programmable logic controllers (PLC).

The process control system may further comprise one or more interface units, or operator interface terminals (OITs) 165, for a user or operator to interface with the system 100 including receiving information and/or providing input. In some embodiments, an OIT 165 may be connected locally to the equipment skid, for example, mounted in a NEMA 4 control panel on the equipment skid. In some embodiments, for example, as shown in FIG. 1A, an OIT 165 may be remotely located and connected to the laboratory water distribution loop system 100 via a wired or wireless connection as would be readily known to a person having an ordinary level of skill in the art. In some embodiments, an OIT 165 may be embodied as a software application on a portable device such as a tablet or a mobile phone.

In some embodiments, the OIT 165 includes a display and an input device, for example, a touchscreen, keyboard, and/or keypad. In some embodiments, the OIT 165 may be used to provide operator monitoring and control of the equipment. In some embodiments, the OIT 165 may be used for setting a temperature in sections of the laboratory water distribution loop system 100. In some embodiments, the OIT 165 may be used to view system conditions, alerts, notifications, alarms, and the like.

The OITs 165 may additionally include various components in order to carry out the various functions described herein as would be apparent to a person having an ordinary level of skill in the art, including but not limited to transmitters, solenoids, analyzers, power sources, sensors, and electrical circuitry, and emergency controls.

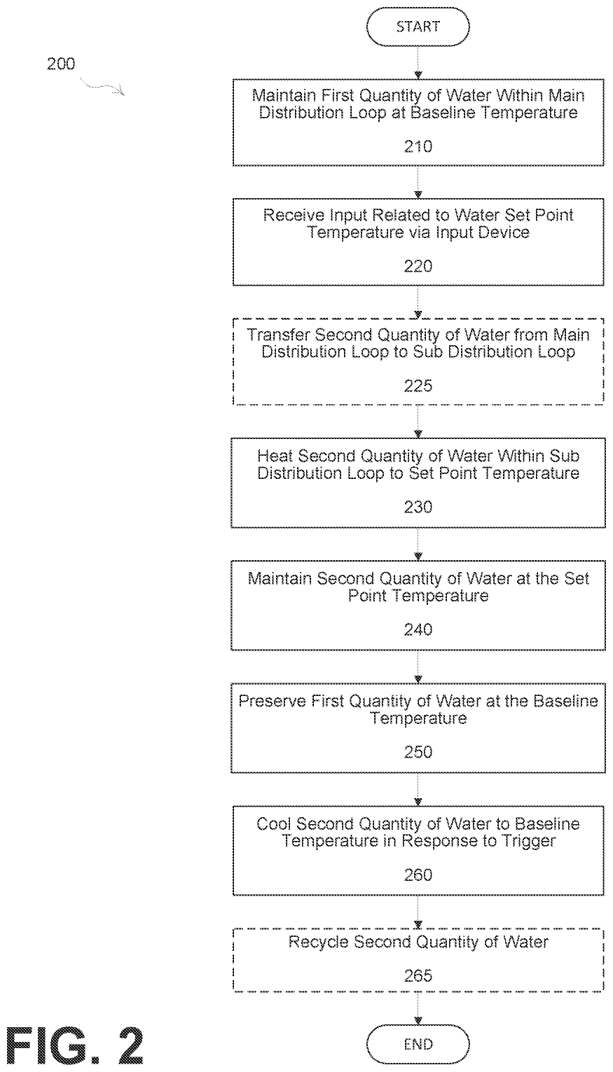

Referring now to FIG. 2, a flow diagram of an illustrative computer-implemented method of regulating water temperature within a sub distribution loop of a water distribution system is depicted in accordance with an embodiment. The method 200 comprises the steps of: maintaining 210 a first quantity of water at a baseline temperature within a main laboratory water distribution loop of the distribution system; receiving 220, through an input device, input related to a set point temperature for the laboratory water; optionally, transferring 225 a second quantity of water from the main distribution loop to a sub distribution loop of the distribution system; heating 230 the second quantity of water within the sub distribution loop of the distribution system from the baseline temperature to the set point temperature; maintaining 240 the second quantity of water at the set point temperature for a period of time; preserving 250 the first quantity of water within the main distribution loop of the distribution system at the baseline temperature for the period of time; cooling 260, in response to a trigger, the second quantity of water from the set point temperature to the baseline temperature; and optionally, recycling 265 the second quantity of water within the sub distribution loop by transferring same to one or more of the main distribution loop or a storage tank.

In some embodiments, the distribution system may include a storage tank, a main distribution loop in fluid communication with the storage tank, and a sub distribution loop extending from the main distribution loop and feeding back thereto. For example, the water distribution system may be a laboratory water distribution loop system 100 as shown in FIG. 1A.

In some embodiments, the step of maintaining 210 the first quantity of water within the main distribution loop at the baseline temperature can further include first transferring the first quantity of water from the storage tank to the main distribution loop, or replenishing the first quantity of water within the main distribution loop from the storage tank, and cooling the first quantity of water to the baseline temperature with a chiller, as described herein, for example, in connection with FIGS. 1A and 1B.

In some embodiments, receiving 220 input related to a set point temperature may comprise receiving input from the user via an OIT to activate a heating cycle. In some embodiments, the input may comprise pressing a button to activate production of heated RODI (i.e., ‘HRODI’) at the set point temperature. In some embodiments, the command selected by the user is generic (for example, “HEAT”) and does not specify a set point temperature. Rather, the set point temperature is fixed and known to the process control system. In some embodiments, the user may be able to set or input a desired set point temperature.

In some embodiments, the optional step of transferring 225 the second quantity of water from the main distribution loop to the sub distribution loop may include first actuating one or more valves (for example, by a processor) from a closed position to an open position to allow the transfer of water between the main distribution loop and the sub distribution loop and, subsequently, causing the one or more valves to move from the open position to the closed position to segregate the main distribution loop and the sub distribution loop. In some embodiments, the step of transferring 225 the second quantity of water from the main distribution loop to the sub distribution loop may include replenishing water within the sub distribution loop from the main distribution loop.

In some embodiments, the main distribution loop and the sub distribution loop are segregated during the steps of maintaining 210, heating 230, maintaining 240, preserving 250, and cooling 260. For example, the method 200 may comprise actuating one or more valves (for example, by a processor) to segregate the main distribution loop and the sub distribution loop. In some embodiments, the distribution loops remain segregated until the water in both distribution loops has been normalized at or near the baseline temperature.

In some embodiments, the steps of heating 230, maintaining 240, preserving 250, and cooling 260 are facilitated by one or more heat exchangers of the distribution system. For example, the distribution system may include heat exchangers as described in full with respect to the laboratory water distribution loop system 100 of FIGS. 1A, 1B and 1C.

The step of cooling 260 may be triggered in a variety of manners. In some embodiments, the trigger comprises a completion of a predetermined time limit. For example, the system may have a pre-programmed time limit, for example, 15 minutes, 30 minutes, 60 minutes, greater than 60 minutes, or individual values or rangers therebetween. In another example, a user may input a time limit in a particular instance. Accordingly, the trigger may be a notification from a timer that the period of time has reached the predetermined time limit and/or an inputted time limit. In some embodiments, the trigger comprises additional input from the user related to termination of the HRODI request. For example, the user may press a button to deactivate HRODI (e.g, a “COOL” button). In some embodiments, the trigger comprises an error or an alarm, for example, an alarm alerting of abnormal or unsafe conditions in the water. For example, the error or alarm may be received from a computing device associated with the distribution system, the water in the distribution system, and/or a facility housing the distribution system (for example, an environmental condition).

In some embodiments, the interface units may provide for additional functionality. In some embodiments, HRODI requests may be planned or scheduled for particular times in the future. For example, an HRODI request may be scheduled manually for a future time based on planned activities. In some embodiments, rather than entering discrete requests, HRODI requests may be planned or initiated based on particular production processes. For example, where a formalized process for production of a specific composition is planned or underway, the process control system may be programmed based on a database of formal production processes to activate HRODI requests according to the formal production process. In some embodiments, a production process may require a plurality of HRODI requests at discrete time intervals. Accordingly, the HRODI requests may be activated based on time. In some embodiments, the process control system may be in communication with additional computing components and may schedule or initiate HRODI requests based on information received therefrom. Accordingly, HRODI requests may be initiated based on the indicated stage of the production process and/or additional information.

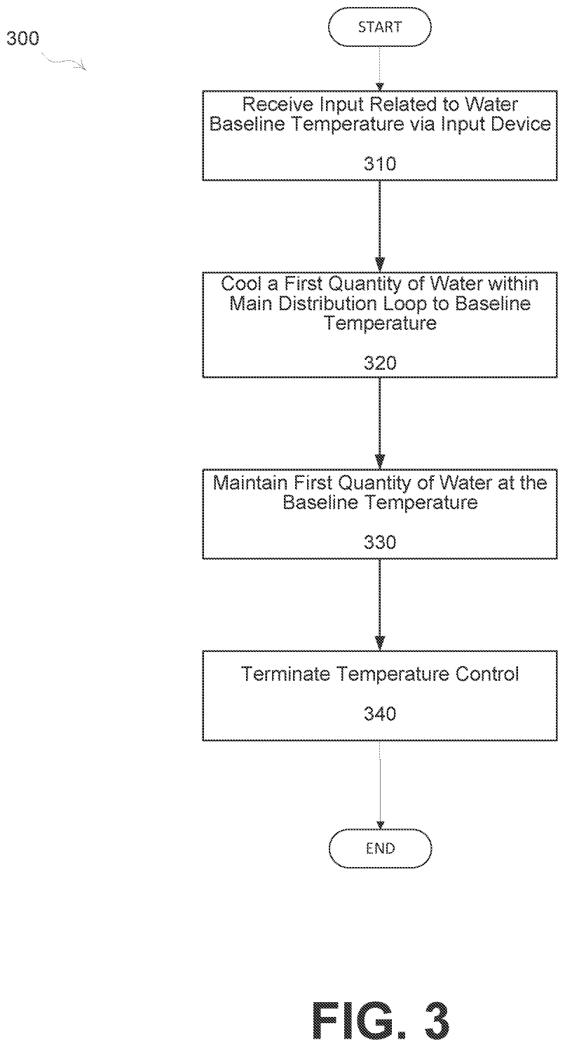

Referring now to FIG. 3, a flow diagram of an illustrative computer-implemented method of regulating water temperature within a main distribution loop of a water distribution system is depicted in accordance with an embodiment. It should be understood that the method 300 may also illustrate a sub-processes of step 210 of method 200, discussed in connection with FIG. 2, namely, maintaining the first quantity of water within the main distribution loop at the baseline temperature. The method 300 comprises: receiving 310, through an input device, input related to a baseline temperature for water; cooling 320 a first quantity of water within a main distribution loop of the distribution system from an initial temperature to a baseline temperature; maintaining 330 the first quantity of water at the baseline temperature continuously for a period of time; and terminating 340 the temperature control in response to a trigger.

In some embodiments, the distribution system may include a storage tank, a main distribution loop in fluid communication with the storage tank, and a sub distribution loop extending from the main distribution loop and feeding back thereto. For example, the water distribution system may be a laboratory water distribution loop system 100 as shown in FIG. 1A.

In some embodiments, receiving 310 input related to a baseline temperature may comprise receiving input from the user via an OIT to activate a cooling cycle. In some embodiments, the input may comprise pressing a button to activate production of cooled RODI (i.e., ‘CRODI’) at the baseline temperature. In some embodiments, the command selected by the user is generic (for example, “COOL”) and does not specify a baseline temperature. Rather, the baseline temperature is selected and known to the process control system. In some embodiments, the user may be able to set or input a desired baseline temperature. In some embodiments, the system is configured to continuously maintain the water at the baseline temperature while the system is operational. A selected baseline temperature would typically be room temperature, which is about 68° F. to 76° F. Accordingly, the input may comprise activating the system, for example, an initial activation, a daily activation, or activation out of a sleep or hibernation mode.

In some embodiments, the main distribution loop and the sub distribution loop are segregated during the steps of the cooling 320 and maintaining 330. For example, the method 200 may be simultaneously performed in order to control the temperature of water within the sub distribution loop without affecting the process 300 for maintaining the baseline temperature of the main distribution loop. One or more valves may be actuated (for example, by a processor) to segregate the main distribution loop and the sub distribution loop. In some embodiments, the distribution loops remain segregated until the water in both distribution loops has been normalized at or near the baseline temperature. In additional embodiments, the water in both distribution loops may be cooled and maintained at the baseline temperature by the process 300, for example, during times when there is not an HRODI request active.

In some embodiments, the steps of cooling 320 and maintaining 330 are facilitated by one or more chillers or heat exchangers of the distribution system. For example, the distribution system may include chillers as described in full with respect to the laboratory water distribution loop system 100 of FIG. 1A-1B.

The step of terminating 340 may be triggered in a variety of manners. In some embodiments, the trigger comprises a completion of a predetermined time limit. For example, the system may have a pre-programmed time limit, for example, 15 minutes, 30 minutes, 1 hour, 6 hours, 12 hours, 24 hours, greater than 24 hours, or individual values or rangers therebetween. In another example, a user may input a time limit in a particular instance. Accordingly, the trigger may be a notification from a timer that the period of time has reached the predetermined time limit and/or an inputted time limit. In some embodiments, the trigger comprises additional input from the user related to termination of the CRODI request. For example, the user may press a button to deactivate CRODI (e.g, an “END” button). In some embodiments, the trigger comprises an error or an alarm, for example, an alarm alerting of abnormal or unsafe conditions in the water. For example, the error or alarm may be received from a computing device associated with the distribution system, the water in the distribution system, and/or a facility housing the distribution system (for example, an environmental condition).

In some embodiments, the interface units may provide for additional functionality. In some embodiments, CRODI requests may be planned or scheduled for particular times in the future. For example, an CRODI request may be scheduled manually for a future time based on planned activities. In some embodiments, rather than entering discrete requests, CRODI requests may be planned or initiated based on particular production processes. For example, where a formalized process for production of a specific composition is planned or underway, the process control system may be programmed based on a database of formal production processes to activate CRODI requests according to the formal production process. In some embodiments, a production process may require a plurality of CRODI requests at discrete time intervals. Accordingly, the CRODI requests may be activated based on time. In some embodiments, the process control system may be in communication with additional computing components and may schedule or initiate CRODI requests based on information received therefrom. Accordingly, CRODI requests may be initiated based on the indicated stage of the production process and/or additional information.

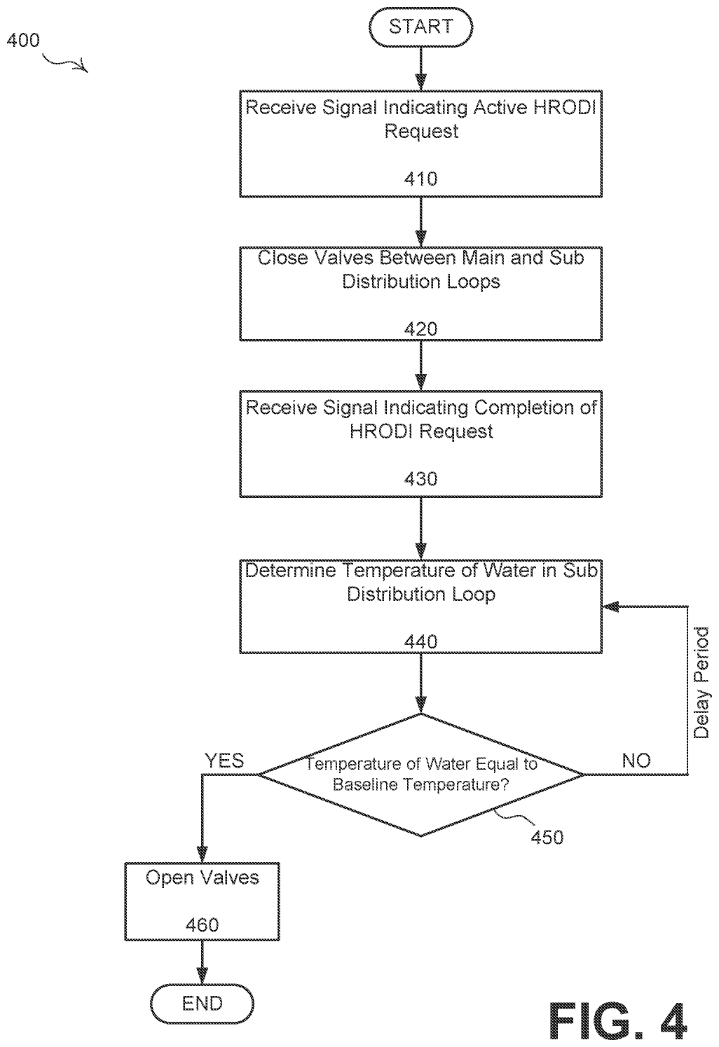

As discussed herein, valves between a main distribution loop and a sub distribution loop may be selectively opened and closed by a processor to allow segregation of the distribution loops and maintaining separate water temperatures in each of the distribution loops. Referring now to FIG. 4, a flow diagram of an illustrative computer-implemented method 400 for regulating flow in the main distribution loop and the sub distribution loop is depicted in accordance with an embodiment. A processor may receive 410 a signal indicating an active HRODI request and close 420 one or more valves between the main distribution loop and the sub distribution loop based on the HRODI request. Accordingly, the temperature of water in the sub distribution loop may be increased from a baseline temperature to a set point temperature without affecting the temperature of water in the main distribution loop, which remains as the baseline temperature. The processor may receive 430 a signal indicating completion of the HRODI request and determine 440 a temperature of water in the sub distribution loop. In step 450, the processor determines if the temperature of water in the sub distribution loop is not equal to the baseline temperature. If a negative determination is made, the processor may return to step 440 after a delay period, for example, 1 minute. However, various delay periods may be utilized as would be apparent to a person having an ordinary level of skill in the art. If a positive determination is made and the temperature of water in the sub distribution loop is substantially equal to the baseline temperature, the processor may proceed to step 460 and open the valve. Accordingly, the water in the sub distribution loop may return to the main distribution loop and/or the storage tank. In embodiments where the sub distribution loop returns directly to the storage tank, the process 400 may be implemented with minor modifications to control a first valve between the main distribution loop and the sub distribution loop and a second valve between the sub distribution loop and the storage tank.

### Laboratory Water Distribution Loop System 500

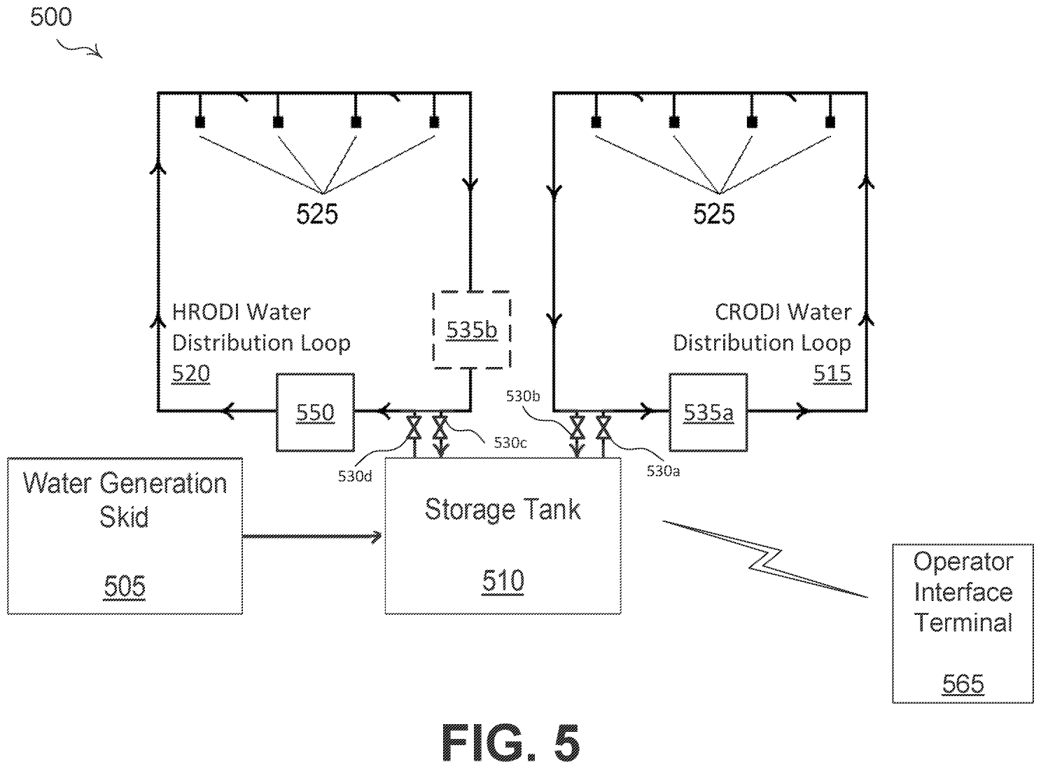

Referring now to FIG. 5, an exemplary laboratory water distribution loop system 500 is depicted in accordance with an embodiment. As shown in FIG. 5, the laboratory water distribution loop system 500 comprises a laboratory water generation skid 505, a storage tank 510 in fluid communication with the laboratory water generation skid 505, a CRODI water distribution loop 515 in fluid communication with the storage tank 510, and a HRODI water distribution loop 520 in fluid communication with the storage tank 510. According to some embodiments of the present disclosure, the system 500 can also include one or more additional HRODI water distribution loops 520 in fluid communication with the storage tank 510. The system further comprises one or more outlets 525, each outlet 525 connected to one of the CRODI water distribution loop 515 and the HRODI water distribution loop 520, for dispensing water therefrom. The CRODI water distribution loop 515 and the HRODI water distribution loop 520 may be selectively in communication with the storage tank 510 by way of one or more valves 530 (for example, valves 530a-d). As shown, the CRODI water distribution loop 515 comprises a chiller 535a configured to maintain the laboratory water at a first (for example, baseline) set point temperature. Likewise, the HRODI water distribution loop 520 may comprise a heat exchanger 550 configured to raise the temperature of laboratory water received from the storage tank 510 to a second (for example, elevated) set point temperature and maintain the water at the second set point temperature. According to some embodiments of the present disclosure, the HRODI water distribution loop 520 may comprise an optional chiller 535b, indicated in dashed lines, which is configured to lower the temperature of the laboratory water in the HRODI water distribution loop 520 to another set point temperature (for example, to the baseline temperature) before returning the laboratory water to the storage tank 510. The system 500 further comprises one or more interface units 565, or operator interface terminals (OITs), for a user or operator to interface with the system 500, including receiving information and/or providing input for control thereof.

### Water Generation Skid

The water generation skid 505 may include a water source for receiving potable water or other water that may be processed into laboratory water. Various processing steps may be used to generate laboratory water that preferably meets the standards of ASTM Type II. For example, the potable water may be filtered by various media, softened, de-chlorinated, deionized, distilled, and/or sterilized by the water generation skid 505. Accordingly, the water generation skid 505 may include various processing components.

In some embodiments, the water generation skid 505 comprises a multimedia filter stage to remove particulate matter from the water. In some embodiments, the multimedia filter may be configured to remove particulates having a size or diameter of 10 μm or greater. In some embodiments, the multimedia filter may be configure to remove particulates having a size or diameter of 5 μm or greater. The multimedia filter may include a plurality of stages or layers in order to gradually remove particulates of progressively smaller sizes. For example, the multimedia filter may include one or more gravel layers, one or more garnet layers, one or more anthracite layers, one or more coarse sand layers, one or more fine sand layers, and/or combinations thereof. In some embodiments, the media layers may be pre-backwashed and drained. In some embodiments, each media layer may be arranged and selected for specific gravity in a manner to allow self-contained re-stratification after backwashing. For example, the media layers may be arranged by specific gravity in ascending order from top to bottom.

In some embodiments, the water generation skid 505 comprises a water softener stage configured to remove hardness ions from the water. In some embodiments, the water softener is configured to remove calcium ions (Ca2+), magnesium ions (Mg2+), and/or other metal ions from the water. In some embodiments, the water softener is configured to remove calcium and magnesium ions through ion exchange. For example, the water may be passed through a filter bed comprising resin beads (for example, beads containing NaCO2 particles), whereby Ca2+ and Mg2+ cations bind to the beads (for example, to the COO-anions) and release sodium cations (Na+) into the water. In some embodiments, the water generation skid 505 may further comprise a brine tank and eductor in communication with the water softener and configured to regenerate the water softener, for example, to maintain a level of NaCO2 particles to continually remove Ca2+ and Mg2+ cations from the water supply. In additional embodiments, the water softener may be configured to treat the water with slaked lime, for example, Ca(OH)2, and soda ash, for example, Na2CO3, in order to precipitate calcium as CaCO3 and magnesium as Mg(OH)2.

In some embodiments, the water generation skid 505 comprises a carbon bed filter stage. In some embodiments, the carbon bed filter is configured to remove chlorine and other trace organic compounds from the water. In some embodiments, the carbon bed filter is configured to break chloramines in the water (for example, NH2Cl, NHCl2, NCl3) into chlorine, ammonia, and/or ammonium.

In some embodiments, the water generation skid 505 comprises one or more mixed deionization (DI) beds configured to remove dissolved ammonia, CO2, and/or trace charged compounds and elements.

In some embodiments, the water generation skid 505 comprises additional types of ion exchange beds for removing organic compounds as would be apparent to a person having an ordinary level of art. The ion exchange beds may include resin beads of varying sizes and properties in order to remove different types of particles. For example, the ion exchange beds may include strong acid cation exchange resins, weak acid cation exchange resins, strong base anion exchange resins, weak base anion exchange resins, and/or chelating resins.

In some embodiments, the water generation skid 505 comprises a reverse osmosis filtration stage configured to remove trace compounds, ammonium, carbon fines and/or other particulate matter, microorganisms, and/or endotoxins from the water. For example, the reverse osmosis stage may include a semi-permeable membrane and a pump configured to apply a pressure greater than an osmotic pressure in the water to cause diffusion of the water through the membrane. Because the efficacy of reverse osmosis is dependent on pressure, solute concentration, and other conditions, the reverse osmosis filtration stage may include one or more sensors configured to monitor conditions within the reverse osmosis unit. For example, the reverse osmosis filtration stage may include an inlet conductivity monitor, a permeate conductivity monitor, a concentrate flow meter, a permeate flow meter, a suction pressure indicator, a high pressure kill switch, and/or an instrument air pressure switch.

In some embodiments, the water generation skid 505 comprises an ultraviolet (UV) light stage configured to inactivate microbes in the water. For example, the water generation skid 505 may include one or more UV light sources configured to emit UV light at a wavelength of 185 nm, 254 nm, 265 nm, and/or additional wavelengths configured to inactivate microbes. In some embodiments, the UV light sources may include quartz lamp sleeves thereon to insulate the UV light sources from temperature changes. In some embodiments, the UV light stage is configured to emit light at a dosage in microwatt seconds per square centimeter (μW-s/cm2) capable of inactivating microbes across the entire volume of water within the UV light stage. The dosage of light emitted within the UV light stage may be based on the internal volume, the light intensity of the one or more UV light sources, and the flow rate of water through the UV light stage. In some embodiments, the UV light stage may include an internal baffle (for example, a helical baffle or static blender) in order to facilitate thorough mixing of water through the UV light stage, thereby causing greater exposure of the water to UV light.

In some embodiments, the water generation skid 505 comprises one or more filter cartridges for removing contaminants from the potable water. For example, one or more of the various stages of the water generation skid 505 as described herein may be provided in the form of a cartridge.

In some embodiments, the water generation skid 505 comprises additional components as would be apparent to a person having an ordinary level of skill in the art to control, maintain, and regulate flow of water through the various stages and process the water in the manners described herein. For example, the water generation skid 505 may include distribution pumps, booster pumps, centrifugal pumps, transmitters, valves, power sources, sensors, and electrical circuitry as would be required to process the water and maintain adequate conditions in the various stages of the water generation skid 505.

### Water Storage Tank

Referring again to FIG. 5, the water generation skid 505 is in fluid communication with the storage tank 510, which is configured to receive laboratory water from the water generation skid 505 and store the water therein. In some embodiments, the storage tank 510 is configured to maintain the quality of the laboratory water after processing by the water generation skid 505. Furthermore, the storage tank 510 may be configured to distribute the water to the distribution loops as further described herein. The storage tank also may be in fluid communication with piping and outlets that are not part of the CRODI water distribution loop 515 and the HRODI water distribution loop 520. As shown, the storage tank 510 may comprise one or more valves 530 for selectively permitting water to flow between the storage tank 510 and one or more of the CRODI water distribution loop 515 (for example, valves 530a and 530b) and the HRODI water distribution loop 520 (for example, valves 530c and 530d).

In some embodiments, the laboratory water received by the storage tank 510 from the water generation skid 505 may be elevated in temperature. For example, the various filtration and processing steps as described herein may result in the laboratory water having an elevated temperature. Accordingly, the water in the storage tank 510 may passively cool down to ambient temperature over time, may be actively cooled using a chiller when entering the CRODI water distribution loop 515, or can be actively heated to maintain, or to further elevate, the temperature of the water using a heat exchanger when entering the HRODI water distribution loop 520, as further described herein. In some embodiments, the storage tank 510 may include one or more of a chiller and a heat exchanger to actively cool and/or heat the laboratory water.

### CRODI and HRODI Water Distribution Loops

With continuing reference to FIG. 5, the CRODI water distribution loop 515 is in fluid communication with the storage tank 510. The CRODI water distribution loop 515 may be configured to receive laboratory water from the storage tank 510 at a first end and circulate the water through the CRODI water distribution loop 515. In some embodiments, the CRODI water distribution loop 515 is additionally in fluid communication with the storage tank 510 at a second end. The CRODI water distribution loop 515 may be configured to return laboratory water to the storage tank 510 at the second end after circulation of the water through the CRODI water distribution loop 515.

In some embodiments, the CRODI water distribution loop 515 is configured to maintain the laboratory water therein at a baseline temperature. For example, the baseline temperature may be about room temperature. In another example, the baseline temperature may be about 18° C. to about 25° C. In a further example, the baseline temperature may be below room temperature, for example, about 18° C. to about 22° C.

In some embodiments, the CRODI water distribution loop 515 comprises a chiller 535a configured to maintain the laboratory water at the baseline temperature. The chiller 535a can be structurally and/or functionally similar to the chiller 135, described in connection with FIGS. 1A and 1B. As such, the chiller 535a may circulate a fluid therethrough in proximity to the CRODI water distribution loop 515 to chill the laboratory water as need to maintain the baseline temperature. The fluid in the chiller 535a may be chilled glycol (for example, propylene glycol), chilled water, or another fluid capable of transferring heat out of the laboratory water. It should be understood that no fluid is exchanged between the chiller 535a and the CRODI water distribution loop 515. Rather, the fluids of the chiller 535a and the CRODI water distribution loop 515 exchange heat through one or more interfacing surfaces therebetween without any direct contact and/or transfer.

In some embodiments, the laboratory water stored in the storage tank 510 may passively cool and maintain at or near the baseline temperature, for example, 25° C. Accordingly, the chiller 535a may not be constantly running. In some embodiments, the chiller 535a is activated when a large batch of laboratory water is generated in order to cool the fresh laboratory water to the baseline temperature. In some embodiments, the CRODI water distribution loop 515 is configured to maintain the laboratory water at a temperature different than the temperature of water in the storage tank 510.

The chiller 535a may include components for controlling movement and/or monitoring the fluid. For example, the chiller 535a may include one or more pumps, valves (for example, two-way valves), power sources, sensors, and/or electrical circuitry. In some embodiments, the chiller 535a may include a compressor, an evaporator, and/or a condenser. Additional manners of maintaining the temperature in the distribution loop are contemplated as would be apparent to a person having an ordinary level of skill in the art.

In some embodiments, a plurality of chillers 535 may be operably connected to the CRODI water distribution loop 515 in order to provide more consistent and/or more accurate temperature control. Furthermore, while the chiller 535a is depicted proximate to a starting portion of the CRODI water distribution loop 515, it should be understood that the chiller 535a may interface with the CRODI water distribution loop 515 at any point along the loop.

In some embodiments, the HRODI water distribution loop 520 is in fluid communication with the storage tank 510 at a first end of the HRODI water distribution loop 520 and may be configured to receive laboratory water therefrom. According to further embodiments, the HRODI water distribution loop 520 may also be in fluid communication with the CRODI water distribution loop 515 via the storage tank 510 and one or more valves. In some embodiments, the HRODI water distribution loop 520 is configured to maintain the laboratory water therein at a set point temperature different from the baseline temperature of the storage tank 510 and/or the CRODI water distribution loop 515. For example, where the laboratory water is maintained by the storage tank 510 and the CRODI water distribution loop 515 at about 18° C. to about 25° C., the HRODI water distribution loop 520 may maintain the laboratory water between about 53° C. to about 57° C. In some embodiments, the set point temperature for the HRODI water distribution loop 520 is variable and may be adjusted based on input from a user and/or parameters associated with a specific procedure.

In some embodiments, the HRODI water distribution loop 520 comprises a heat exchanger 550 configured to raise the temperature of the laboratory water received from the CRODI water distribution loop 515 to the set point temperature and maintain the water at the set point temperature. The heat exchanger 550 can be structurally and/or functionally similar to the heat exchanger 150, described in connection with FIGS. 1A and 1C. As such, the heat exchanger 550 may circulate a heated fluid (for example, steam or hot water) therethrough in proximity to the HRODI water distribution loop 520 to continuously heat the laboratory water and maintain the set point temperature, for example, about 57° C. In some embodiments, the heat exchanger 550 may include or may be in fluid communication with a boiler for receiving the heated fluid, for example, steam. It should be understood that no fluid is exchanged between the heat exchanger 550 and the HRODI water distribution loop 520. Rather, the fluids of the heat exchanger 550 and the HRODI water distribution loop 520 exchange heat through one or more interfacing surfaces therebetween without any direct contact and/or transfer. In some embodiments, the heat exchanger 550 may be configured as a closed recirculating system. In some embodiments, the heat exchanger 550 may be configured as an open recirculating system. Various types of heating units and configurations thereof may be implemented herein as would be known to a person having an ordinary level of skill in the art.

The heat exchanger 550 may include additional components for controlling movement and/or monitoring the heating fluid. For example, the heat exchanger 550 may include one or more pumps, valves (for example, two-way valves), power sources, sensors, and/or electrical circuitry.

In some embodiments, a plurality of heat exchangers 550 may be operably connected to the HRODI water distribution loop 520 in order to provide more consistent and/or more accurate temperature control. Furthermore, while the heat exchanger 550 is depicted proximate to an end portion of the HRODI water distribution loop 520, it should be understood that the heat exchanger 550 may interface with the HRODI water distribution loop 520 at any point along the loop.

In some embodiments, the HRODI water distribution loop 520 may comprise an optional chiller 535b configured to lower the temperature of the laboratory water in the HRODI water distribution loop 520 to another set point temperature (for example, to the baseline temperature) before returning the laboratory water to the storage tank 510. The chiller 535b can be structurally and/or functionally similar to the chiller 535a, described in connection with CRODI water distribution loop 515, and chiller 135, described in connection with FIGS. 1A and 1B. As such, the chiller 535b may circulate a fluid therethrough in proximity to the HRODI water distribution loop 520 to chill the laboratory water and reduce the temperature thereof as needed. The fluid in the chiller 535b may be chilled glycol (for example, propylene glycol), chilled water, or another fluid capable of transferring heat out of the laboratory water. It should be understood that no fluid is exchanged between the chiller 535b and the HRODI water distribution loop 520. Rather, the fluids of the chiller 535b and the HRODI water distribution loop 520 exchange heat through one or more interfacing surfaces therebetween without any direct contact and/or transfer.

The chiller 535b may include components for controlling movement and/or monitoring the fluid. For example, the chiller 535b may include one or more pumps, valves (for example, two-way valves), power sources, sensors, and/or electrical circuitry. In some embodiments, the chiller 535b may include a compressor, an evaporator, and/or a condenser. Additional manners of reducing the temperature of the laboratory water in the HRODI water distribution loop 620 are contemplated as would be apparent to a person having an ordinary level of skill in the art. Furthermore, while the chiller 535b is depicted proximate to an end portion of the HRODI water distribution loop 520, it should be understood that the chiller 535b may interface with the HRODI water distribution loop 520 at any point along the loop.

It should be understood that the elevated temperature in the HRODI water distribution loop 520 is a selective feature which may be activated and deactivated. Accordingly, during certain time periods, the laboratory water in the HRODI water distribution loop 520 may be not be elevated. In some embodiments, the HRODI water distribution loop 520 may have a baseline temperature substantially matching the CRODI water distribution loop 515 and/or storage tank 510. For example, the temperature of the laboratory water in the HRODI water distribution loop 520 may be ambient as described herein.

In some embodiments, the HRODI water distribution loop 520 may circulate the laboratory water back to the storage tank 510 in order to recycle the laboratory water that is not used at the set point temperature. In some embodiments, the HRODI water distribution loop 520 may be in fluid communication with the CRODI water distribution loop 515 via the storage tank 510. In some embodiments, as shown in FIG. 5, the HRODI water distribution loop 520 may be in direct fluid communication with the storage tank 510 and may return water directly thereto. In some embodiments, the heat exchanger 550 of the HRODI water distribution loop 520 and/or an additional heat exchanger or chiller (for example, chiller 535b) may cool the laboratory water within the HRODI water distribution loop 520 back to the baseline temperature before dispensing to the storage tank 510. In further embodiments, the HRODI water distribution loop 520 may allow the laboratory water to passively cool to the baseline temperature within the HRODI water distribution loop 520 before transferring the water to the storage tank 510. Additional manners of reducing the temperature of the laboratory water in the HRODI water distribution loop 520 are contemplated as would be apparent to a person having an ordinary level of skill in the art.

By recycling the heated laboratory water from the HRODI water distribution loop 520 back to the storage tank 510, the laboratory water is conserved and waste is minimized. Generally, production of highly purified laboratory water is expensive, time consuming, and energy intensive due to the equipment, consumables, and degree of precision required. Optionally, costs may be significantly reduced by recycling the heated laboratory water from the HRODI water distribution loop 520 as described herein. By the systems and methods as described, immediate availability of the water and efficient use of the water may be simultaneously achieved.

In some embodiments, the CRODI water distribution loop 515 and the HRODI water distribution loop 520 may be selectively in communication via the storage tank 510 and one or more omnidirectional or bidirectional valves (not shown). Accordingly, after laboratory water is transferred between the CRODI water distribution loop 515, the HRODI water distribution loop 520, and the storage tank 510, laboratory water in each of the HRODI water distribution loop 520 and the CRODI water distribution loop 515 may be segregated by shutting the one or more valves in order to maintain the water in the respective distribution loops at respective separate set point temperatures. For example, water in the HRODI water distribution loop 520 may circulate therein while the one or more valves are closed. As water is consumed from the HRODI water distribution loop 520, one or more valves may be opened to replenish the water supply from the storage tank 510 (for example, via valve 530d). When the use of the water at the set point temperature is complete in a given instance, valves may be opened to return the water to the storage tank 510 (for example, via valve 530c).

The CRODI water and HRODI water distribution loop systems can be operated manually, manually and automated, and fully automated. For automated operation, computer processors and electrically controlled valves and heat exchangers can be employed. Provided herein are exemplary approaches for automated control using computer technology.

In some embodiments, the valves 130 are in electrical communication with a processor as further described herein and may be controlled by the processor via electrical signals. In some embodiments, the valves 130 are operably connected to an actuator to open and close the valves. In some embodiments, the valves 130 may be two-way valves. In some embodiments, the valves 130 may be zero-static tee valves. In some embodiments, the valves 130 may be solenoid valves. In some embodiments, the valves 130 may be operably connected servo motors to open and close the valves. Additional types of valves are contemplated herein as would be apparent to a person having an ordinary level of skill in the art.

The CRODI water distribution loop 515 and the HRODI water distribution loop 520 may each form a complete loop in a “chase-the-tail” configuration to allow circulation within the respective loops. In additional embodiments, as shown in FIG. 5, ingress to and egress from each of the CRODI water distribution loop 515 and the HRODI water distribution loop 520 may occur through separate connecting channels. For example, ingress from the storage tank 510 to the CRODI water distribution loop 515 and the HRODI water distribution loop 520 may occur through respective valves 530a and 530d and egress to the storage tank 510 from the CRODI water distribution loop 515 and the HRODI water distribution loop 520 may occur through respective valves 530b and 530c.

The CRODI water distribution loop 515 and the HRODI water distribution loop 520 may further comprise one or more outlets 525 for dispensing the laboratory water therefrom. The outlets 525 may be provided across a variety of dedicated spaces within a facility. In some embodiments, the outlets 525 for each of the distribution loops 515 and 520 are intended for unique purposes. For example, the chilled or ambient water in the CRODI water distribution loop 515 may be sufficient for washing, rinsing, and chemical and/or biotechnological processes. However, heated water at precisely controlled temperature may be required for preparing media, preparing buffers, and the like and can be provided by the outlets 525 in communication with the HRODI water distribution loop 520.

In some embodiments, at least some of the outlets 525 may be manual outlets, for example, faucets, sinks, wall mounted water outlets, media/buffer outlets, and the like which are manually operable by a user. In some embodiments, at least some of the outlets 525 may be automatic outlets that connect the supply of laboratory water to appliances such as refrigerators, washing appliances for glassware and other laboratory supplies, incubators, and/or autoclave machines. It should be understood that any type of outlet 525 may be configured as manual or automatic according to function or preference.

In some embodiments, the CRODI water distribution loop 515 may comprise one or more pumps dedicated to circulating water within the CRODI water distribution loop 515. In some embodiments, the HRODI water distribution loop 520 may comprise one or more pumps dedicated to circulating water within the HRODI water distribution loop 520. For example, as shown in FIG. 5, water may circulate independently within each of the CRODI water distribution loop 515 and the HRODI water distribution loop 520 while one or more valves therebetween (for example, valves 530a-d) are closed. Accordingly, each of the CRODI water distribution loop 515 and the HRODI water distribution loop 520 may have one or more dedicated pumps such that water may be circulated therein, even when segregated from one another. According to another example, water may circulate through both of the CRODI water distribution loop 515 and the HRODI water distribution loop 520, for example, via the storage tank 510, while one or more valves therebetween (for example, valves 530a-d) are open. Accordingly, the CRODI water distribution loop 515 and the HRODI water distribution loop 520 may share one or more pumps such that water may be circulated therethrough, when not segregated from one another. In some embodiments, the one or more pumps of the CRODI water distribution loop 515 and the HRODI water distribution loop 520 are centrifugal pumps. However, additional types of pumps may be utilized herein as would be apparent to a person having an ordinary level of skill in the art.

The piping forming the CRODI water distribution loop 515, the HRODI water distribution loop 520, the outlets 525, and/or additional piping in the system 500 may comprise carbon steel piping and fittings. In some embodiments, the piping may be insulated, for example, with fiberglass insulation and/or and a jacket in order to efficiently maintain temperatures of water within the piping. In some embodiments, the jacket may be a PVC jacket (for example, for indoor piping) or an aluminum jacket (for example, for outdoor piping).

In some embodiments, the CRODI water distribution loop 515 and the HRODI water distribution loop 520 may be operably connected to one or more exhaust fans configured to exhaust energy from the distribution system. For example, exhaust fans for each of the water distribution loops may operate simultaneously to exhaust heat and maintain the conditions of the distribution system. In some embodiments, the exhaust fans may form an energy recovery unit comprising one or more coils and one or more strobic fans that may recycle exhausted energy (for example, heat) from the distribution system for heating air within a facility and other purposes.

Each of the laboratory water distribution loops 515 and 520 may include an array of sensors and/or alarms configured to monitor one or more parameters in the laboratory water. For example, the array of sensors may be configured to monitor temperature, conductivity, total organic carbon, distribution pressure, and/or loop pressure. In some embodiments, a notification or alarm may sound wherein one or more parameters are approaching or outside of a desired range.

Each of the distribution loops 515 and 520 may be configured with sensors and electrical control components configure to regulate the laboratory water in a proportional-integral-derivative (PID) control loop. In the PID loop, the sensors may be used to continuously assess deviation from set parameters and the control device may implement corrections to restore the set parameters with minimal delay. For example, temperature sensors may be used to monitor temperature in a virtually continuous fashion and the heat exchanger may be used to implement corrections as need to maintain the baseline temperature and/or set point temperature for each distribution loop.

It should be understood that any of the various valves described herein with respect to components of the system 500 may comprise any type of valve that would be known to a person having an ordinary level of skill in the art. For example, the valves may comprise two-way valves, zero-static tee valves, solenoid valves, servo motor-controlled valves, and the like.

In some embodiments, any of the disclosed features or components may be redundantly provided for any of the purposes described herein may be utilized to achieve more consistent conditions and/or reduce a probability of failure. For example, heat exchangers, fans, distribution pumps, sensors, and the like may be provided in duplicate or triplicate for any of the purposes described herein.

### Control Systems and Methods

The laboratory water distribution loop system 500 as described herein may be controlled via a process control system. In some embodiments, the process control system comprises one or more processors and a non-transitory, computer-readable medium storing instructions executable by the one or more processors. In some embodiments, the process control system comprises one or more programmable logic controllers (PLC).

The process control system may further comprise one or more interface units, or operator interface terminals (OITs) 565, for a user or operator to interface with the system 500, including receiving information and/or providing input. In some embodiments, an OIT 565 may be connected locally to the equipment skid, for example, mounted in a NEMA 4 control panel on the equipment skid. In some embodiments, an OIT 565 may be remotely located and connected to the laboratory water distribution loop system 500 via a wired or wireless connection as would be readily known to a person having an ordinary level of skill in the art. In some embodiments, an OIT 565 may be embodied as a software application on a portable device such as a tablet or a mobile phone.

In some embodiments, the OIT 565 includes a display and an input device, for example, a touchscreen, keyboard, and/or keypad. In some embodiments, the OIT 565 may be used to provide operator monitoring and control of the equipment. In some embodiments, the OIT 565 may be used for setting a temperature in sections of the laboratory water distribution loop system 500. In some embodiments, the OIT may be used to view system conditions, alerts, notifications, alarms, and the like.

The OITs 565 may additionally include various components in order to carry out the various functions described herein as would be apparent to a person having an ordinary level of skill in the art, including but not limited to transmitters, solenoids, analyzers, power sources, sensors, and electrical circuitry, and emergency controls.

### Laboratory Water Distribution Loop System 600

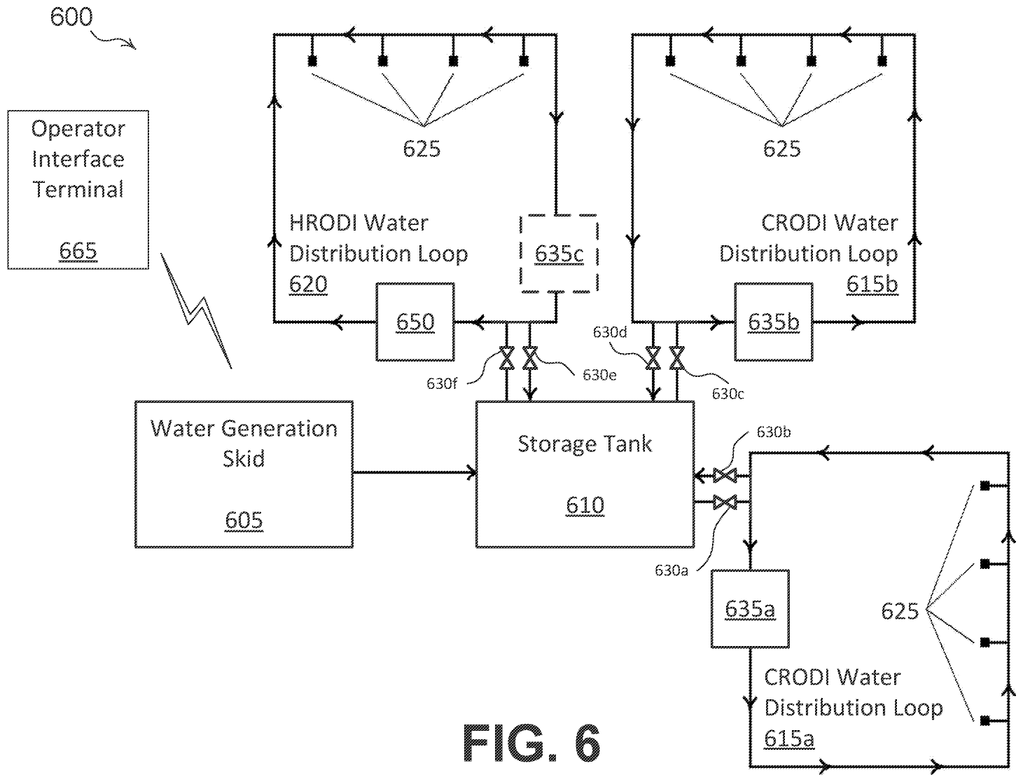

Referring now to FIG. 6, an exemplary laboratory water distribution loop system 600 is depicted in accordance with an embodiment. As shown in FIG. 6, the laboratory water distribution loop system 600 comprises a laboratory water generation skid 605, a storage tank 610 in fluid communication with the laboratory water generation skid 605, first and second CRODI water distribution loops 615a and 615b (together, CRODI water distribution loops 615) in fluid communication with the storage tank 610, and a HRODI water distribution loop 620 in fluid communication with the storage tank 610. According to some embodiments of the present disclosure, the system 600 can also include one or more additional HRODI water distribution loops 620 in fluid communication with the storage tank 610. It should be understood that the first and second CRODI water distribution loops 615a and 615b may be structurally and functionally similar to one another. Accordingly, unless otherwise noted, the first and second CRODI water distribution loops 615a and 615b are referred to jointly herein. The system further comprises one or more outlets 625, each outlet 625 connected to one of the CRODI water distribution loops 615 and the HRODI water distribution loop 620, for dispensing laboratory water therefrom. The CRODI water distribution loops 615 and the HRODI water distribution loop 620 may be selectively in communication with the storage tank 610 by way of one or more valves 630 (for example, valves 630a-f). As shown, each of the CRODI water distribution loops 615 may comprise a chiller 635 (for example, chillers 635a and 635b) configured to maintain the laboratory water at a first (for example, baseline) set point temperature. Likewise, the HRODI water distribution loop 620 may comprise a heat exchanger 650 configured to raise the temperature of laboratory water received from the storage tank 610 to a second (for example, elevated) set point temperature and maintain the water at the second set point temperature. According to some embodiments of the present disclosure, the HRODI water distribution loop 620 may comprise an optional chiller 635c, indicated in dashed lines, which is configured to lower the temperature of the laboratory water in the HRODI water distribution loop 620 to another set point temperature (for example, to the baseline temperature) before returning the laboratory water to the storage tank 610. The system 600 further comprises one or more interface units, or operator interface terminals (OITs) 665, for a user or operator to interface with the system 600, including receiving information and/or providing input for control thereof.

### Water Generation Skid

The water generation skid 605 may include a water source for receiving potable water or other water that may be processed into laboratory water. Various processing steps may be used to generate laboratory water that preferably meets the standards of ASTM Type II. For example, the potable water may be filtered by various media, softened, de-chlorinated, deionized, distilled, and/or sterilized by the water generation skid 605. Accordingly, the water generation skid 605 may include various processing components.

In some embodiments, the water generation skid 605 comprises a multimedia filter stage to remove particulate matter from the water. In some embodiments, the multimedia filter may be configured to remove particulates having a size or diameter of 10 μm or greater. In some embodiments, the multimedia filter may be configure to remove particulates having a size or diameter of 5 μm or greater. The multimedia filter may include a plurality of stages or layers in order to gradually remove particulates of progressively smaller sizes. For example, the multimedia filter may include one or more gravel layers, one or more garnet layers, one or more anthracite layers, one or more coarse sand layers, one or more fine sand layers, and/or combinations thereof. In some embodiments, the media layers may be pre-backwashed and drained. In some embodiments, each media layer may be arranged and selected for specific gravity in a manner to allow self-contained re-stratification after backwashing. For example, the media layers may be arranged by specific gravity in ascending order from top to bottom.

In some embodiments, the water generation skid 605 comprises a water softener stage configured to remove hardness ions from the water. In some embodiments, the water softener is configured to remove calcium ions (Ca2+), magnesium ions (Mg2+), and/or other metal ions from the water. In some embodiments, the water softener is configured to remove calcium and magnesium ions through ion exchange. For example, the water may be passed through a filter bed comprising resin beads (for example, beads containing NaCO2 particles), whereby Ca2+ and Mg2+ cations bind to the beads (for example, to the COO— anions) and release sodium cations (Na+) into the water. In some embodiments, the water generation skid 605 may further comprise a brine tank and eductor in communication with the water softener and configured to regenerate the water softener, for example, to maintain a level of NaCO2 particles to continually remove Ca2+ and Mg2+ cations from the water supply. In additional embodiments, the water softener may be configured to treat the water with slaked lime, for example, Ca(OH)2, and soda ash, for example, Na2CO3, in order to precipitate calcium as CaCO3 and magnesium as Mg(OH)2.

In some embodiments, the water generation skid 605 comprises a carbon bed filter stage. In some embodiments, the carbon bed filter is configured to remove chlorine and other trace organic compounds from the water. In some embodiments, the carbon bed filter is configured to break chloramines in the water (for example, NH2Cl, NHCl2, NCl3) into chlorine, ammonia, and/or ammonium.

In some embodiments, the water generation skid 605 comprises one or more mixed deionization (DI) beds configured to remove dissolved ammonia, CO2, and/or trace charged compounds and elements.

In some embodiments, the water generation skid 605 comprises additional types of ion exchange beds for removing organic compounds as would be apparent to a person having an ordinary level of art. The ion exchange beds may include resin beads of varying sizes and properties in order to remove different types of particles. For example, the ion exchange beds may include strong acid cation exchange resins, weak acid cation exchange resins, strong base anion exchange resins, weak base anion exchange resins, and/or chelating resins.

In some embodiments, the water generation skid 605 comprises a reverse osmosis filtration stage configured to remove trace compounds, ammonium, carbon fines and/or other particulate matter, microorganisms, and/or endotoxins from the water. For example, the reverse osmosis stage may include a semi-permeable membrane and a pump configured to apply a pressure greater than an osmotic pressure in the water to cause diffusion of the water through the membrane. Because the efficacy of reverse osmosis is dependent on pressure, solute concentration, and other conditions, the reverse osmosis filtration stage may include one or more sensors configured to monitor conditions within the reverse osmosis unit. For example, the reverse osmosis filtration stage may include an inlet conductivity monitor, a permeate conductivity monitor, a concentrate flow meter, a permeate flow meter, a suction pressure indicator, a high pressure kill switch, and/or an instrument air pressure switch.

In some embodiments, the water generation skid 605 comprises an ultraviolet (UV) light stage configured to inactivate microbes in the water. For example, the water generation skid 605 may include one or more UV light sources configured to emit UV light at a wavelength of 185 nm, 254 nm, 265 nm, and/or additional wavelengths configured to inactivate microbes. In some embodiments, the UV light sources may include quartz lamp sleeves thereon to insulate the UV light sources from temperature changes. In some embodiments, the UV light stage is configured to emit light at a dosage in microwatt seconds per square centimeter (μW-s/cm2) capable of inactivating microbes across the entire volume of water within the UV light stage. The dosage of light emitted within the UV light stage may be based on the internal volume, the light intensity of the one or more UV light sources, and the flow rate of water through the UV light stage. In some embodiments, the UV light stage may include an internal baffle (for example, a helical baffle or static blender) in order to facilitate thorough mixing of water through the UV light stage, thereby causing greater exposure of the water to UV light.

In some embodiments, the water generation skid 605 comprises one or more filter cartridges for removing contaminants from the potable water. For example, one or more of the various stages of the water generation skid 605 as described herein may be provided in the form of a cartridge.

In some embodiments, the water generation skid 605 comprises additional components as would be apparent to a person having an ordinary level of skill in the art to control, maintain, and regulate flow of water through the various stages and process the water in the manners described herein. For example, the water generation skid 605 may include distribution pumps, booster pumps, centrifugal pumps, transmitters, valves, power sources, sensors, and electrical circuitry as would be required to process the water and maintain adequate conditions in the various stages of the water generation skid 605.

### Water Storage Tank

Referring again to FIG. 6, the water generation skid 605 is in fluid communication with the storage tank 610, which is configured to receive laboratory water from the water generation skid 605 and store the water therein. In some embodiments, the storage tank 610 is configured to maintain the quality of the laboratory water after processing by the water generation skid 605. Furthermore, the storage tank 610 may be configured to distribute the water to the distribution loops as further described herein. The storage tank 610 also may be in fluid communication with piping and outlets that are not part of the CRODI water distribution loops 615 and the HRODI water distribution loop 620. As shown, the storage tank 610 may comprise one or more valves 630 for selectively permitting water to flow between the storage tank 610 and one or more of the CRODI water distribution loops 615 (for example, valves 630a-d) and the HRODI water distribution loop 620 (for example, valves 630e and 630f).

In some embodiments, the laboratory water received by the storage tank 610 from the water generation skid 605 may be elevated in temperature. For example, the various filtration and processing steps as described herein may result in the laboratory water having an elevated temperature. Accordingly, the water in the storage tank 610 may passively cool down to ambient temperature over time, may be actively cooled using a chiller when entering the CRODI water distribution loops 615, or can be actively heated to maintain, or to further elevate, the temperature of the water using a heat exchanger when entering the HRODI water distribution loop 620, as further described herein. In some embodiments, the storage tank 610 may include one or more of a chiller and a heat exchanger to actively cool and/or heat the laboratory water.

### CRODI and HRODI Water Distribution Loops

With continuing reference to FIG. 6, the CRODI water distribution loops 615 are in fluid communication with the storage tank 610. Each of the CRODI water distribution loops 615 may be configured to receive laboratory water from the storage tank 610 at a first end and circulate the water through the CRODI water distribution loop 615. In some embodiments, each of the CRODI water distribution loops 615 may additionally be in fluid communication with the storage tank 610 at a second end. The CRODI water distribution loops 615 may be configured to return laboratory water to the storage tank 610 after circulation and/or distribution of the laboratory water through the CRODI water distribution loop 615.

In some embodiments, the CRODI water distribution loops 615 are configured to maintain the laboratory water therein at a baseline temperature. For example, the baseline temperature may be about room temperature. In another example, the baseline temperature may be about 18° C. to about 25° C. In a further example, the baseline temperature may be below room temperature, for example, about 18° C. to about 22° C.

In some embodiments, each of the CRODI water distribution loops 615 comprises a chiller 635 configured to maintain the laboratory water at the baseline temperature. In some embodiments, the CRODI water distribution loops 615 may be in communication with one or more shared chillers 635 configured to maintain the laboratory water at the baseline temperature. The chillers 635 of the CRODI water distribution loops 615 can be structurally and/or functionally similar to the chiller 135, described in connection with FIGS. 1A and 1B. As such, the chillers 635 may circulate a fluid therethrough in proximity to respective CRODI water distribution loops 615 to chill the laboratory water as need to maintain the baseline temperature. The fluid in the chillers 635 may be chilled glycol (for example, propylene glycol), chilled water, or another fluid capable of transferring heat out of the laboratory water. It should be understood that no fluid is exchanged between the chillers 635 and the CRODI water distribution loops 615. Rather, the fluids of the chillers 635 and the CRODI water distribution loops 615 exchange heat through one or more interfacing surfaces therebetween without any direct contact and/or transfer.

In some embodiments, the laboratory water stored in the storage tank 610 may passively cool and maintain at or near the baseline temperature, for example, 25° C. Accordingly, the chillers 635 of the CRODI water distribution loops 615 may not be constantly running. In some embodiments, the chillers 635 are activated when a large batch of laboratory water is generated and transferred to one or both of the CRODI water distribution loops 615 in order to cool the fresh laboratory water to the baseline temperature. In some embodiments, the CRODI water distribution loops 615 are configured to maintain the laboratory water at a temperature different than the temperature of water in the storage tank 610.

The chillers 635 of the CRODI water distribution loops 615 may include components for controlling movement and/or monitoring the fluid. For example, the chillers 635 may include one or more pumps, valves (for example, two-way valves), power sources, sensors, and/or electrical circuitry. In some embodiments, the chillers 635 may include a compressor, an evaporator, and/or a condenser. Additional manners of maintaining the temperature in the distribution loop are contemplated as would be apparent to a person having an ordinary level of skill in the art.

In some embodiments, a plurality of chillers 635 may be operably connected to each of the CRODI water distribution loops 615 in order to provide more consistent and/or more accurate temperature control. Furthermore, while the chillers 635 are depicted proximate to starting portions of their respective CRODI water distribution loops 615, it should be understood that the chillers 635 may interface with the CRODI water distribution loops 615 at any point along the loops.

In some embodiments, the HRODI water distribution loop 620 is in fluid communication with the storage tank 610 at a first end of the HRODI water distribution loop 620 and may be configured to receive laboratory water therefrom. According to further embodiments, the HRODI water distribution loop 620 may also be in fluid communication with the one or more of the CRODI water distribution loops 615 via the storage tank 610 and one or more valves. In some embodiments, the HRODI water distribution loop 620 is configured to maintain the laboratory water therein at a set point temperature different from the baseline temperature of the storage tank 610 and/or the CRODI water distribution loops 615. For example, where the laboratory water is maintained by the storage tank 610 and the CRODI water distribution loops 615 at about 18° C. to about 25° C., the HRODI water distribution loop 620 may maintain the laboratory water between about 53° C. to about 57° C. In some embodiments, the set point temperature for the HRODI water distribution loop 620 is variable and may be adjusted based on input from a user and/or parameters associated with a specific procedure.

In some embodiments, the HRODI water distribution loop 620 comprises a heat exchanger 650 configured to raise the temperature of the laboratory water received from the storage tank 610 to the set point temperature and maintain the water at the set point temperature. The heat exchanger 650 can be structurally and/or functionally similar to the heat exchanger 150, described in connection with FIGS. 1A and 1C. As such, the heat exchanger 650 may circulate a heated fluid (for example, steam or hot water) therethrough in proximity to the HRODI water distribution loop 620 to continuously heat the laboratory water and maintain the set point temperature, for example, about 57° C. In some embodiments, the heat exchanger 650 may include or may be in fluid communication with a boiler for receiving the heated fluid, for example, steam. It should be understood that no fluid is exchanged between the heat exchanger 650 and the HRODI water distribution loop 620. Rather, the fluids of the heat exchanger 650 and the HRODI water distribution loop 620 exchange heat through one or more interfacing surfaces therebetween without any direct contact and/or transfer. In some embodiments, the heat exchanger 650 may be configured as a closed recirculating system. In some embodiments, the heat exchanger 650 may be configured as an open recirculating system. Various types of heating units and configurations thereof may be implemented herein as would be known to a person having an ordinary level of skill in the art.

The heat exchanger 650 may include additional components for controlling movement and/or monitoring the heating fluid. For example, the heat exchanger 650 may include one or more pumps, valves (for example, two-way valves), power sources, sensors, and/or electrical circuitry.

In some embodiments, a plurality of heat exchangers 650 may be operably connected to the HRODI water distribution loop 620 in order to provide more consistent and/or more accurate temperature control. Furthermore, while the heat exchanger 650 is depicted proximate to an end portion of the HRODI water distribution loop 620, it should be understood that the heat exchanger 650 may interface with the HRODI water distribution loop 620 at any point along the loop.

In some embodiments, the HRODI water distribution loop 620 may comprise an optional chiller 635c configured to lower the temperature of the laboratory water in the HRODI water distribution loop 620 to another set point temperature (for example, to the baseline temperature) before returning the laboratory water to the storage tank 610. The chiller 635c can be structurally and/or functionally similar to the chillers 635a and 635b, described in connection with the CRODI water distribution loops 615, and chiller 135, described in connection with FIGS. 1A and 1B. As such, the chiller 635c may circulate a fluid therethrough in proximity to the HRODI water distribution loop 620 to chill the laboratory water and reduce the temperature thereof as needed. The fluid in the chiller 635c may be chilled glycol (for example, propylene glycol), chilled water, or another fluid capable of transferring heat out of the laboratory water. It should be understood that no fluid is exchanged between the chiller 635c and the HRODI water distribution loop 620. Rather, the fluids of the chiller 635c and the HRODI water distribution loop 620 exchange heat through one or more interfacing surfaces therebetween without any direct contact and/or transfer.

The chiller 635c may include components for controlling movement and/or monitoring the fluid. For example, the chiller 635c may include one or more pumps, valves (for example, two-way valves), power sources, sensors, and/or electrical circuitry. In some embodiments, the chiller 635c may include a compressor, an evaporator, and/or a condenser. Additional manners of reducing the temperature of the laboratory water in the distribution loop are contemplated as would be apparent to a person having an ordinary level of skill in the art. Furthermore, while the chiller 635c is depicted proximate to an end portion of the HRODI water distribution loop 620, it should be understood that the chiller 635c may interface with the HRODI water distribution loop 620 at any point along the loop.

It should be understood that the elevated temperature in the HRODI water distribution loop 620 is a selective feature which may be activated and deactivated. Accordingly, during certain time periods, the laboratory water in the HRODI water distribution loop 620 may be not be elevated. In some embodiments, the HRODI water distribution loop 620 may have a baseline temperature substantially matching the CRODI water distribution loops 615 and/or storage tank 610. For example, the temperature of the laboratory water in the HRODI water distribution loop 620 may be ambient as described herein.

In some embodiments, the HRODI water distribution loop 620 may circulate the laboratory water back to the storage tank 610 in order to recycle the laboratory water that is not used at the elevated set point temperature. In some embodiments, the HRODI water distribution loop 620 may be in fluid communication with one or more of the CRODI water distribution loops 615 via the storage tank 610. In some embodiments, as shown in FIG. 6, the HRODI water distribution loop 620 may be in direct fluid communication with the storage tank 610 and may return water directly thereto. In some embodiments, the heat exchanger 650 of the HRODI water distribution loop 620 and/or an additional heat exchanger or chiller may cool the laboratory water within the HRODI water distribution loop 620 back to the baseline temperature before transferring the water to the storage tank 610. In further embodiments, the HRODI water distribution loop 620 may allow the laboratory water to passively cool to the baseline temperature within the HRODI water distribution loop 620 before transferring the water to the storage tank 610. Additional manners of reducing the temperature in the HRODI water distribution loop 620 are contemplated as would be apparent to a person having an ordinary level of skill in the art.

By recycling the heated laboratory water from the HRODI water distribution loop 620 back to the storage tank 610, the laboratory water is conserved and waste is minimized. Generally, production of highly purified laboratory water is expensive, time consuming, and energy intensive due to the equipment, consumables, and degree of precision required. Optionally, costs may be significantly reduced by recycling the heated laboratory water from the HRODI water distribution loop 620 as described herein. By the systems and methods as described, immediate availability of the water and efficient use of the water may be simultaneously achieved.

In some embodiments, one or more of the CRODI water distribution loops 615 and the HRODI water distribution loop 620 may be selectively in communication via the storage tank 610 and one or more omnidirectional or bidirectional valves. For example, one or more valves may be positioned in a channel connecting the HRODI water distribution loop 620 to one or more of the CRODI water distribution loops 615. Accordingly, after laboratory water is transferred between the storage tank 610, the CRODI water distribution loops 615, and the HRODI water distribution loop 620, laboratory water in each of the HRODI water distribution loop 620 and the CRODI water distribution loops 615 may be segregated by shutting the one or more valves in order to maintain the water in the respective distribution loops at respective separate set point temperatures. For example, water in the HRODI water distribution loop 620 may circulate therein while the one or more valves are closed. As water is consumed from the HRODI water distribution loop 620, one or more valves may be opened to replenish the water supply from the storage tank 610 (for example, via valve 630f). When the use of the water at the set point temperature is complete in a given instance, valves may be opened to return the water to the storage tank 610 (for example, via valve 630e).

The CRODI water and HRODI water distribution loop systems can be operated manually, manually and automated, and fully automated. For automated operation, computer processors and electrically controlled valves and heat exchangers can be employed. Provided herein are exemplary approaches for automated control using computer technology.

In some embodiments, the valves 630 are in electrical communication with a processor as further described herein and may be controlled by the processor via electrical signals. In some embodiments, the valves 630 are operably connected to an actuator to open and close the valves. In some embodiments, the valves 630 may be two-way valves. In some embodiments, the valves 630 may be zero-static tee valves. In some embodiments, the valves 630 may be solenoid valves. In some embodiments, the valves 630 may be operably connected servo motors to open and close the valves. Additional types of valves are contemplated herein as would be apparent to a person having an ordinary level of skill in the art.

The CRODI water distribution loops 615 and the HRODI water distribution loop 620 may each form a complete loop in a “chase-the-tail” configuration to allow circulation within the respective loops. As shown in FIG. 6, ingress to and egress from each of the CRODI water distribution loops 615 and the HRODI water distribution loop 620 may occur through separate connecting channels. For example, ingress from the storage tank 610 to the CRODI water distribution loop 615a, the CRODI water distribution loop 615b, and the HRODI water distribution loop 620 may occur through respective valves 630a, 630c, and 630f and egress to the storage tank 610 from the CRODI water distribution loop 615a, the CRODI water distribution loop 615b, and the HRODI water distribution loop 620 may occur through respective valves 630b, 630d, and 630e.

The CRODI water distribution loops 615 and the HRODI water distribution loop 620 may further comprise one or more outlets 625 for dispensing the laboratory water therefrom. The outlets 625 may be provided across a variety of dedicated spaces within a facility. In some embodiments, the outlets 625 for each of the distribution loops 615 and 620 are intended for unique purposes. For example, the chilled or ambient water in the CRODI water distribution loops 615 may be sufficient for washing, rinsing, and chemical and/or biotechnological processes. However, heated water at precisely controlled temperature may be required for preparing media, preparing buffers, and the like and can be provided by the outlets 625 in communication with the HRODI water distribution loop 620.

In some embodiments, at least some of the outlets 625 may be manual outlets, for example, faucets, sinks, wall mounted water outlets, media/buffer outlets, and the like which are manually operable by a user. In some embodiments, at least some of the outlets 625 may be automatic outlets that connect the supply of laboratory water to appliances such as refrigerators, washing appliances for glassware and other laboratory supplies, incubators, and/or autoclave machines. It should be understood that any type of outlet 625 may be configured as manual or automatic according to function or preference.

In some embodiments, the CRODI water distribution loops 615 may comprise one or more pumps dedicated to circulating water within the CRODI water distribution loops 615. In some embodiments, the HRODI water distribution loop 620 may comprise one or more pumps dedicated to circulating water within the HRODI water distribution loop 620. For example, as shown in FIG. 6, water may circulate independently within each of the CRODI water distribution loops 615 and the HRODI water distribution loop 620 while one or more valves therebetween (for example, valves 630a-f) are closed. Accordingly, each of the CRODI water distribution loops 615 and the HRODI water distribution loop 620 may have one or more dedicated pumps such that water may be circulated therein, even when segregated from the other distribution loops. According to another example, water may circulate through one or more of the CRODI water distribution loops 615 and the HRODI water distribution loop 620, for example, via the storage tank 610, while one or more valves therebetween (for example, valves 630a-f) are open. Accordingly, one or more of the CRODI water distribution loops 615 and the HRODI water distribution loop 620 may share one or more pumps such that water may be circulated therethrough, when not segregated from one another. In some embodiments, one or more pumps of the CRODI water distribution loops 615 and the HRODI water distribution loop 620 are centrifugal pumps. However, additional types of pumps may be utilized herein as would be apparent to a person having an ordinary level of skill in the art.

The piping forming the CRODI water distribution loops 615, the HRODI water distribution loop 620, the outlets 625, and/or additional piping in the system 600 may comprise carbon steel piping and fittings. In some embodiments, the piping may be insulated, for example, with fiberglass insulation and/or and a jacket in order to efficiently maintain temperatures of water within the piping. In some embodiments, the jacket may be a PVC jacket (for example, for indoor piping) or an aluminum jacket (for example, for outdoor piping).

In some embodiments, the CRODI water distribution loops 615 and the HRODI water distribution loop 620 may be operably connected to one or more exhaust fans configured to exhaust energy from the distribution system. For example, exhaust fans for each of the water distribution loops may operate simultaneously to exhaust heat and maintain the conditions of the distribution system. In some embodiments, the exhaust fans may form an energy recovery unit comprising one or more coils and one or more strobic fans that may recycle exhausted energy (for example, heat) from the distribution system for heating air within a facility and other purposes.

Each of the laboratory water distribution loops 615 and 620 may include an array of sensors and/or alarms configured to monitor one or more parameters in the laboratory water. For example, the array of sensors may be configured to monitor temperature, conductivity, total organic carbon, distribution pressure, and/or loop pressure. In some embodiments, a notification or alarm may sound wherein one or more parameters are approaching or outside of a desired range.

Each of the distribution loops 615 and 620 may be configured with sensors and electrical control components configure to regulate the laboratory water in a proportional-integral-derivative (PID) control loop. In the PID loop, the sensors may be used to continuously assess deviation from set parameters and the control device may implement corrections to restore the set parameters with minimal delay. For example, temperature sensors may be used to monitor temperature in a virtually continuous fashion and the heat exchanger may be used to implement corrections as need to maintain the baseline temperature and/or set point temperature for each distribution loop.

It should be understood that any of the various valves described herein with respect to components of the system 600 may comprise any type of valve that would be known to a person having an ordinary level of skill in the art. For example, the valves may comprise two-way valves, zero-static tee valves, solenoid valves, servo motor-controlled valves, and the like.

In some embodiments, any of the disclosed features or components may be redundantly provided for any of the purposes described herein may be utilized to achieve more consistent conditions and/or reduce a probability of failure. For example, heat exchangers, fans, distribution pumps, sensors, and the like may be provided in duplicate or triplicate for any of the purposes described herein. Further components also can be added, such as manifolds/mixers to provide fluid communication between loops, should different temperatures be desired while avoiding the need to alter temperature set points.

It should be understood that particularly in viral production processes, a high degree of specificity is required when preparing materials. Various production processes may be extremely sensitive to the temperature of water and other materials utilizes and the processes may additionally be time sensitive. Accordingly, while conventional practices may entail drawing water from a common source and heating or cooling as necessary, the typical apparatuses may not be equipped with sensors and/or feedback systems to allow for fine control of temperature in the manner required. Furthermore, time sensitive production processes involving several steps may not tolerate the delays associated with conventional methods of preparing temperature-specific laboratory water. Accordingly, the systems disclosed herein advantageously overcome the issues with conventional systems and methods by providing a precise temperature-controlled water source that may be pre-set, maintained, and made available on demand. Furthermore, unused temperature-controlled water is cooled and recycled such that waste of purified water is minimized by the systems and methods herein.

### Control Systems and Methods

The laboratory water distribution loop system 600 as described herein may be controlled via a process control system. In some embodiments, the process control system comprises one or more processors and a non-transitory, computer-readable medium storing instructions executable by the one or more processors. In some embodiments, the process control system comprises one or more programmable logic controllers (PLC).

The process control system may further comprise one or more interface units, or operator interface terminals (OITs) 665, for a user or operator to interface with the system 600, including receiving information and/or providing input. In some embodiments, an OIT 665 may be connected locally to the equipment skid, for example, mounted in a NEMA 4 control panel on the equipment skid. In some embodiments, an OIT 665 may be remotely located and connected to the laboratory water distribution loop system 600 via a wired or wireless connection as would be readily known to a person having an ordinary level of skill in the art. In some embodiments, an OIT 665 may be embodied as a software application on a portable device such as a tablet or a mobile phone.

In some embodiments, the OIT 665 includes a display and an input device, for example, a touchscreen, keyboard, and/or keypad. In some embodiments, the OIT 665 may be used to provide operator monitoring and control of the equipment. In some embodiments, the OIT 665 may be used for setting a temperature in sections of the laboratory water distribution loop system 600. In some embodiments, the OIT may be used to view system conditions, alerts, notifications, alarms, and the like.

The OITs 665 may additionally include various components in order to carry out the various functions described herein as would be apparent to a person having an ordinary level of skill in the art, including but not limited to transmitters, solenoids, analyzers, power sources, sensors, and electrical circuitry, and emergency controls.

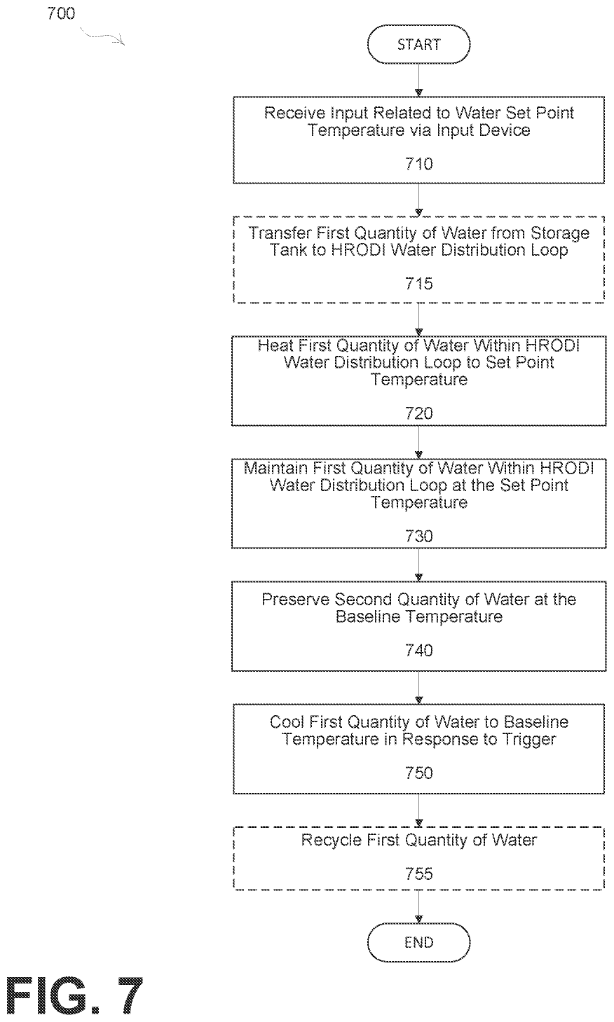

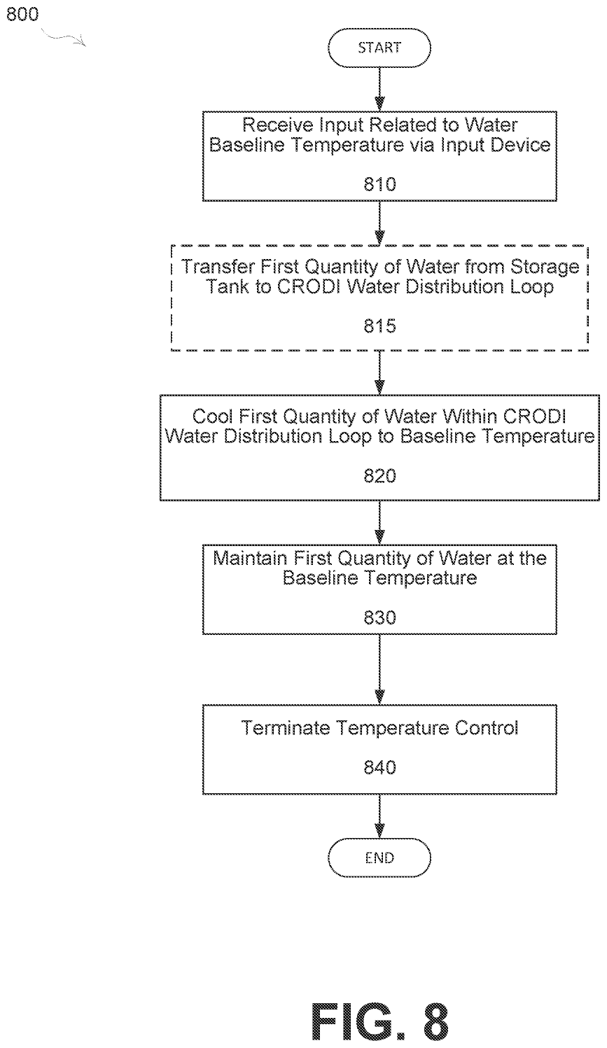

FIGS. 7 and 8 are flow diagrams illustrating computer-implemented methods of regulating water temperature within one or more of the laboratory water distribution loops of the water distribution systems 500 and 600 described in connection with FIGS. 5 and 6, respectively. Specifically, FIG. 7 illustrates a computer-implemented method, indicated generally at 700, for regulating water temperature within one or more of the HRODI water distribution loops 520 and 620 of the laboratory water distribution systems 500 and 600 and FIG. 8 illustrates a computer-implemented method, indicated generally at 800, for regulating water temperature within one or more of the CRODI water distribution loops 515, 615a, and 615b of the laboratory water distribution systems 500 and 600.

Referring now to FIG. 7, a flow diagram of an illustrative computer-implemented method of regulating water temperature within a HRODI water distribution loop (for example, distribution loops 520 and 620, described in connection with respective FIGS. 5 and 6) of a water distribution system is depicted in accordance with an embodiment of the present disclosure. The method 700 may comprise the steps of: receiving 710, through an input device, input related to a set point temperature for the laboratory water; optionally, transferring 715 a first quantity of water from a storage tank to a HRODI water distribution loop of the distribution system; heating 720 the first quantity of water within the HRODI water distribution loop of the distribution system from a baseline temperature to the set point temperature; maintaining 730 the first quantity of water at the set point temperature for a period of time; preserving 740 a second quantity of water at the baseline temperature for the period of time; cooling 750, in response to a trigger, the first quantity of water from the set point temperature to the baseline temperature; and optionally, recycling 755 the second quantity of water within the HRODI water distribution loop by transferring same to one or more of the storage tank and a CRODI water distribution loop.

In some embodiments, the distribution system may include a storage tank, one or more CRODI water distribution loops in fluid communication with the storage tank, and a HRODI water distribution loop in fluid communication with the storage tank. For example, the distribution system may include a single CRODI water distribution loop, as shown in FIG. 5, or the distribution system may include multiple CRODI water distribution loops, as shown in FIG. 6. In some embodiments, the CRODI water distribution loops may be isolated from the HRODI water distribution loops, but for common fluid communication with the storage tank. For example, the water distribution system may be a laboratory water distribution loop system 500 or 600, as shown in FIGS. 5 and 6. In some embodiments, the CRODI water distribution loops may be in selective fluid communication with the HRODI water distribution loops by way of one or more channels and/or controllable valves extending therebetween to facilitate the transfer of laboratory water therebetween.

In some embodiments, receiving 710 input related to a set point temperature may comprise receiving input from the user via an OIT (for example, OIT 565 or 665) to activate a heating cycle. In some embodiments, the input may comprise pressing a button to activate production of heated RODI (i.e., ‘HRODI’) at the set point temperature. In some embodiments, the command selected by the user is generic (for example, “HEAT”) and does not specify a set point temperature. Rather, the set point temperature is fixed and known to the process control system. In some embodiments, the user may be able to set or input a desired set point temperature.

In some embodiments, the optional step of transferring 715 a first quantity of water from the storage tank to the HRODI water distribution loop may include first actuating one or more valves (for example, by a processor) from a closed position to an open position to allow the transfer of water between the storage tank and the HRODI water distribution loop and, subsequently, causing the one or more valves to move from the open position to the closed position to segregate the storage tank from the HRODI water distribution loop. In some embodiments, the step of transferring 715 the first quantity of water from the storage tank to the HRODI water distribution loop may include replenishing consumed water from the storage tank.

In some embodiments, the HRODI water distribution loop and the storage tank are segregated during the steps of heating 720, maintaining 730, preserving 740, and cooling 750. For example, the method 700 may comprise actuating one or more valves (for example, by a processor) to segregate the HRODI water distribution loop and the storage tank. In some embodiments, the water in the HRODI water distribution loop remains segregated until the water theein has been normalized at or near the baseline temperature.

In some embodiments, the steps of heating 720, maintaining 730, preserving 740, and cooling 750 are facilitated by one or more heat exchangers of the distribution system. For example, the distribution system may include heat exchangers as described in full with respect to the laboratory water distribution loop systems 100, 500, and 600 of the present disclosure.

The step of cooling 750 may be triggered in a variety of manners. In some embodiments, the trigger comprises a completion of a predetermined time limit. For example, the system may have a pre-programmed time limit, for example, 15 minutes, 30 minutes, 60 minutes, greater than 60 minutes, or individual values or rangers therebetween. In another example, a user may input a time limit in a particular instance. Accordingly, the trigger may be a notification from a timer that the period of time has reached the predetermined time limit and/or an inputted time limit. In some embodiments, the trigger comprises additional input from the user related to termination of the HRODI request. For example, the user may press a button to deactivate HRODI (e.g, a “COOL” button). In some embodiments, the trigger comprises an error or an alarm, for example, an alarm alerting of abnormal or unsafe conditions in the water. For example, the error or alarm may be received from a computing device associated with the distribution system, the water in the distribution system, and/or a facility housing the distribution system (for example, an environmental condition).

In some embodiments, the interface units may (for example, operator interface terminals 565 and 665) provide for additional functionality. In some embodiments, HRODI requests may be planned or scheduled for particular times in the future. For example, an HRODI request may be scheduled manually for a future time based on planned activities. In some embodiments, rather than entering discrete requests, HRODI requests may be planned or initiated based on particular production processes. For example, where a formalized process for production of a specific composition is planned or underway, the process control system may be programmed based on a database of formal production processes to activate HRODI requests according to the formal production process. In some embodiments, a production process may require a plurality of HRODI requests at discrete time intervals. Accordingly, the HRODI requests may be activated based on time. In some embodiments, the process control system may be in communication with additional computing components and may schedule or initiate HRODI requests based on information received therefrom. Accordingly, HRODI requests may be initiated based on the indicated stage of the production process and/or additional information.

Referring now to FIG. 8, a flow diagram of an illustrative computer-implemented method, indicated generally at 800, of regulating water temperature within one or more CRODI water distribution loops (for example, distribution loops 515, 615a, and/or 615b, discussed in connection with FIGS. 5 and 6) of a water distribution system is depicted in accordance with an embodiment of the present disclosure. The method 800 comprises: receiving 810, through an input device, input related to a baseline temperature for water; optionally, transferring 815 a first quantity of water from a storage tank to one or more CRODI water distribution loops of the distribution system; cooling 820 the first quantity of water within the one or more CRODI water distribution loops of the distribution system from an initial temperature to a baseline temperature; maintaining 830 the first quantity of water at the baseline temperature continuously for a period of time; and terminating 840 the temperature control in response to a trigger.

In some embodiments, the distribution system may include a storage tank, one or more CRODI water distribution loops in fluid communication with the storage tank, and a HRODI water distribution loop in fluid communication with the storage tank. For example, the distribution system may include a single CRODI water distribution loop, as shown in FIG. 5, or the distribution system may include multiple CRODI water distribution loops, as shown in FIG. 6. In some embodiments, the CRODI water distribution loops may be isolated from the HRODI water distribution loops, but for common fluid communication with the storage tank. For example, the water distribution system may be a laboratory water distribution loop system 500 or 600, as shown in FIGS. 5 and 6. In some embodiments, the CRODI water distribution loops may be in selective fluid communication with the HRODI water distribution loops by way of one or more channels and/or controllable valves extending therebetween to facilitate the transfer of laboratory water therebetween.

In some embodiments, receiving 810 input related to a baseline temperature may comprise receiving input from the user via an OIT to activate a cooling cycle. In some embodiments, the input may comprise pressing a button to activate production of cooled RODI (i.e., ‘CRODI’) at the baseline temperature. In some embodiments, the command selected by the user is generic (for example, “COOL”) and does not specify a baseline temperature. Rather, the baseline temperature is selected and known to the process control system. In some embodiments, the user may be able to set or input a desired baseline temperature. In some embodiments, the system is configured to continuously maintain the water at the baseline temperature while the system is operational. A selected baseline temperature would typically be room temperature, which is about 68° F. to 76° F. Accordingly, the input may comprise activating the system, for example, an initial activation, a daily activation, or activation out of a sleep or hibernation mode.

In some embodiments, the optional step of transferring 815 a first quantity of water from the storage tank to the CRODI water distribution loop may include first actuating one or more valves (for example, by a processor) from a closed position to an open position to allow the transfer of water between the storage tank and the CRODI water distribution loop and, subsequently, causing the one or more valves to move from the open position to the closed position to segregate the storage tank from the CRODI water distribution loop. In some embodiments, the step of transferring 815 the first quantity of water from the storage tank to the CRODI water distribution loop may include replenishing consumed water from the storage tank.

In some embodiments, the CRODI water distribution loop and storage tank are segregated during the steps of the cooling 820 and maintaining 830. For example, the method 800 may be simultaneously performed with the method 700 in order to control the temperature of water within the HRODI water distribution loop without affecting the process 800 for maintaining the baseline temperature of the CRODI water distribution loop. One or more valves may be actuated (for example, by a processor) to segregate one or more of the CRODI water distribution loops from the storage tank. In some embodiments, the CRODI water distribution loops remain segregated until the water in both the distribution loops and the storage tank has been normalized at or near the baseline temperature. In additional embodiments, the water in both the CRODI water distribution loops and/or the HRODI water distribution loops may be cooled and maintained at the baseline temperature by the process 800, for example, during times when there is not an HRODI request active.

In some embodiments, the steps of cooling 820 and maintaining 830 are facilitated by one or more chillers or heat exchangers of the distribution system. For example, the distribution system may include chillers as described in full with respect to the laboratory water distribution loop systems 100, 500, and 600 of the present disclosure.

The step of terminating 840 may be triggered in a variety of manners. In some embodiments, the trigger comprises a completion of a predetermined time limit. For example, the system may have a pre-programmed time limit, for example, 15 minutes, 30 minutes, 1 hour, 6 hours, 12 hours, 24 hours, greater than 24 hours, or individual values or rangers therebetween. In another example, a user may input a time limit in a particular instance. Accordingly, the trigger may be a notification from a timer that the period of time has reached the predetermined time limit and/or an inputted time limit. In some embodiments, the trigger comprises additional input from the user related to termination of the CRODI request. For example, the user may press a button to deactivate CRODI (e.g, an “END” button). In some embodiments, the trigger comprises an error or an alarm, for example, an alarm alerting of abnormal or unsafe conditions in the water. For example, the error or alarm may be received from a computing device associated with the distribution system, the water in the distribution system, and/or a facility housing the distribution system (for example, an environmental condition).

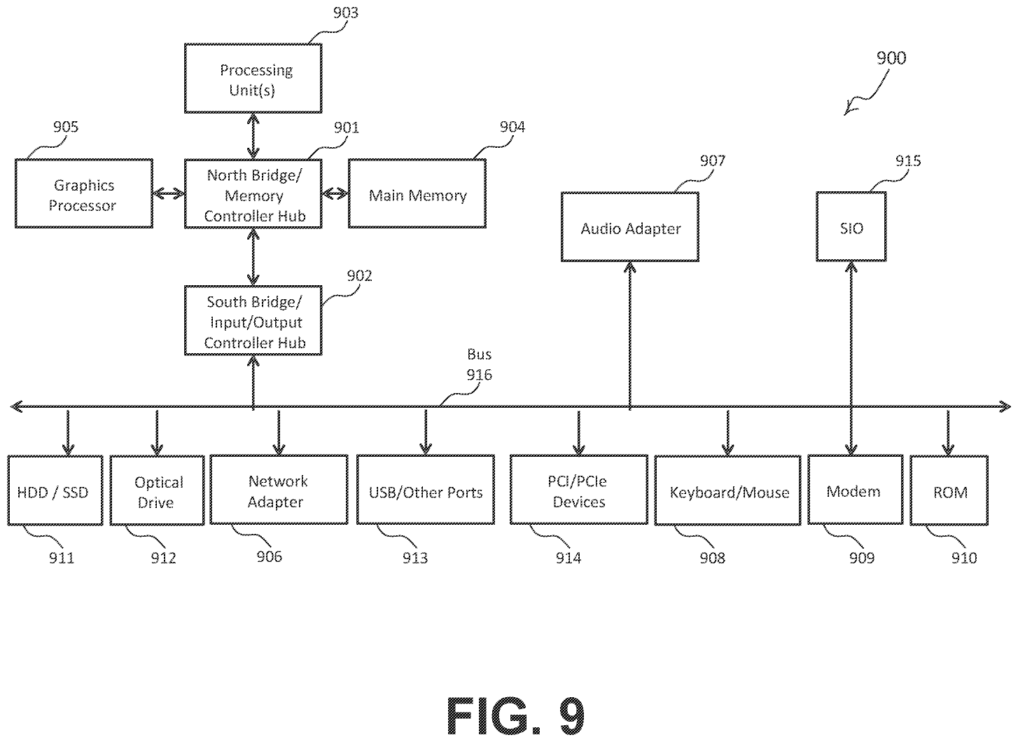

In some embodiments, the interface units may provide for additional functionality. In some embodiments, CRODI requests may be planned or scheduled for particular times in the future. For example, an CRODI request may be scheduled manually for a future time based on planned activities. In some embodiments, rather than entering discrete requests, CRODI requests may be planned or initiated based on particular production processes. For example, where a formalized process for production of a specific composition is planned or underway, the process control system may be programmed based on a database of formal production processes to activate CRODI requests according to the formal production process. In some embodiments, a production process may require a plurality of CRODI requests at discrete time intervals. Accordingly, the CRODI requests may be activated based on time. In some embodiments, the process control system may be in communication with additional computing components and may schedule or initiate CRODI requests based on information received therefrom. Accordingly, CRODI requests may be initiated based on the indicated stage of the production process and/or additional information. FIG. 9 illustrates a block diagram of an exemplary data processing system 900 in which embodiments are implemented. The data processing system 900 is an example of a computer, such as a server or client, in which computer usable code or instructions implementing the processes (for example, methods 200, 300, 400, 700 and/or 800) for illustrative embodiments of the present inventions are located. In some embodiments, the data processing system 900 may be a server computing device. For example, data processing system 900 can be implemented in a server or another similar computing device operably connected to a laboratory water distribution loop system, for example, distribution systems 100, 500, and 600 as described above. The data processing system 900 can be configured to, for example, transmit and receive information related to conditions of the laboratory water and/or input from a user.

In the depicted example, data processing system 900 can employ a hub architecture including a north bridge and memory controller hub (NB/MCH) 901 and south bridge and input/output (I/O) controller hub (SB/ICH) 902. Processing unit 903, main memory 904, and graphics processor 905 can be connected to the NB/MCH 901. Graphics processor 905 can be connected to the NB/MCH 901 through, for example, an accelerated graphics port (AGP).

In the depicted example, a network adapter 906 connects to the SB/ICH 902. An audio adapter 907, keyboard and mouse adapter 908, modem 909, read only memory (ROM) 910, hard disk drive (HDD) and/or solid state drive (SSD) 911, optical drive (for example, CD or DVD) 912, universal serial bus (USB) ports and other communication ports 913, and PCl/PCIe devices 914 may connect to the SB/ICH 902 through a bus system 916. PCl/PCIe devices 914 may include Ethernet adapters, add-in cards, and PC cards for notebook computers. ROM 910 may be, for example, a flash basic input/output system (BIOS). The HDD/SSD 911 and optical drive 912 can use an integrated drive electronics (IDE) or serial advanced technology attachment (SATA) interface. A super I/O (SIO) device 915 can be connected to the SB/ICH 902.

An operating system can run on the processing unit 903. The operating system can coordinate and provide control of various components within the data processing system 900. As a client, the operating system can be a commercially available operating system. An object-oriented programming system, such as the Java™ programming system, may run in conjunction with the operating system and provide calls to the operating system from the object-oriented programs or applications executing on the data processing system 900. As a server, the data processing system 900 can be, for example, an IBM® eServer™ System® running the Advanced Interactive Executive operating system or the Linux operating system. The data processing system 900 can be a symmetric multiprocessor (SMP) system that can include a plurality of processors in the processing unit 903. Alternatively, a single processor system may be employed.

Instructions for the operating system, the object-oriented programming system, and applications or programs are located on storage devices, such as the HDD/SSD 911, and are loaded into the main memory 904 for execution by the processing unit 903. The processes for embodiments described herein can be performed by the processing unit 903 using computer usable program code, which can be located in a memory such as, for example, main memory 904, ROM 910, or in one or more peripheral devices. The bus system 916 can be comprised of one or more busses. The bus system 916 can be implemented using any type of communication fabric or architecture that can provide for a transfer of data between different components or devices attached to the fabric or architecture. A communication unit such as the modem 909 or the network adapter 906 can include one or more devices that can be used to transmit and receive data.

Those of ordinary skill in the art will appreciate that the hardware depicted in FIG. 9 may vary depending on the implementation. Other internal hardware or peripheral devices, such as flash memory, equivalent non-volatile memory, or optical disk drives may be used in addition to or in place of the hardware depicted. Moreover, the data processing system 900 can take the form of any of a number of different data processing systems, including but not limited to, client computing devices, server computing devices, tablet computers, laptop computers, telephone or other communication devices, personal digital assistants, and the like. Essentially, data processing system 900 can be any known or later developed data processing system without architectural limitation.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

Various of the above-disclosed and other features and functions, or alternatives thereof, may be combined into many other different systems or applications. Various alternatives, modifications, variations or improvements therein may be subsequently made by those skilled in the art, each of which is also intended to be encompassed by the disclosed embodiments.

1. A laboratory water generation and distribution system capable of distributing laboratory water at different temperatures, wherein the system comprises:
(A) a laboratory water generation section configured to treat potable water to generate laboratory water;
(B) a laboratory water distribution section comprising:
(1) a laboratory water storage tank,
(2) a main distribution loop in fluid communication with the laboratory water storage tank and configured to receive the laboratory water therefrom to distribute through at least one outlet laboratory water at a first temperature range, and
(3) a sub distribution loop operatively connected to the main distribution loop via a valve and configured to receive the laboratory water therefrom to distribute through at least one outlet laboratory water at a second temperature range, wherein the sub distribution loop also can return the laboratory water to the main distribution loop;
(C) an Operator Interface Terminal (OIT); and
(D) one or more processors.

2. The system of claim 1, wherein the laboratory water generation section comprises a multimedia filter, a cartridge filter, a water softening medium, an activated carbon bed, a reverse osmosis unit, a UV light, an ion exchange bed vessel and a mixed bed ion exchange vessel.

3-14. (canceled)

15. The system of claim 1, wherein the laboratory water in the main distribution loop is maintained at a temperature between about 18° C. to about 25° C.

16. (canceled)

17. The system of claim 1, wherein the sub distribution loop is configured to heat and maintain the laboratory water in the sub distribution loop to a temperature between about 53° C. to about 57° C.

18. The system of claim 17, wherein the sub distribution loop is configured to cool the laboratory water in the sub distribution loop to a temperature between about 18° C. to about 25° C. prior to dispensing the laboratory water to the main distribution loop.

19-23. (canceled)

24. A method of generating laboratory water and distributing laboratory water at different temperatures, the method comprising the steps of:
(A) treating potable water using laboratory water generation section to generate laboratory water; and
(B) distributing laboratory water using a laboratory water distribution section comprising:
(1) a laboratory water storage tank,
(2) a main distribution loop in fluid communication with the laboratory water storage tank and receiving the laboratory water therefrom to distribute laboratory water through at least one outlet at a first temperature range, and
(3) a sub distribution loop operatively connected to the main distribution loop via a valve and receiving the laboratory water therefrom to distribute laboratory water through at least one outlet at a second temperature range, wherein the sub distribution loop also can return laboratory water to the main distribution loop,
wherein the distributing is controlled by a at least one processor

25. (canceled)

26. The method of claim 24, further comprising steps that are controlled by a processor:
receiving heating input related to a set point temperature for water;
heating a first quantity of water within the sub distribution loop from a baseline temperature to the set point temperature;
maintaining the first quantity of water at the set point temperature for a period of time;
preserving a second quantity of water within the main distribution loop at the baseline temperature for the period of time; and
cooling the first quantity of water from the set point temperature to the baseline temperature in response to a trigger.

27. The method of claim 24, wherein the heating input comprises a request for heated water at the set point temperature.

28. The method of claim 24, wherein the trigger comprises a notification that the period of time has reached a predetermined time limit.

29. The method of claim 24, wherein the heating input comprises a time limit, wherein the trigger comprises a notification that the period of time has reached the time limit.

30-34. (canceled)

35. The method of claim 24, wherein the laboratory water generation section comprises a multimedia filter, a cartridge filter, a water softening medium, an activated carbon bed, a reverse osmosis unit, a UV light, an ion exchange bed vessel and a mixed bed ion exchange vessel.

36. The method according to claim 24, wherein the laboratory water in the main distribution loop is maintained at a temperature between about 18° C. to about 25° C.

37. (canceled)

38. The method of claim 24, wherein laboratory water in the sub distribution loop is heated to and maintained at a temperature between about 53° C. to about 57° C.

39. The method of claim 38 wherein the laboratory water in the sub distribution loop is re-cooled to a temperature between about 18° C. to about 25° C. prior to dispensing the laboratory water to the main distribution loop.

40-54. (canceled)

55. A laboratory water generation and distribution system capable of distributing laboratory water at different temperatures, wherein the system comprises:
(A) a laboratory water generation section configured to treat potable water to generate laboratory water;
(B) a laboratory water storage section comprising a laboratory water storage tank in fluid communication with the laboratory water generation section and configured to receive the laboratory water therefrom;
(C) a laboratory water distribution section comprising:
(1) at least one cooled water distribution loop in fluid communication with the laboratory water storage tank, the cooled water distribution loop configured to receive the laboratory water from the storage tank and to distribute the laboratory water at a first temperature range through one or more outlets, and
(2) at least one heated water distribution loop in fluid communication with the laboratory water storage tank, the heated water distribution loop configured to receive the laboratory water from the storage tank and to distribute the laboratory water at a second temperature range through one or more outlets, the second temperature range exceeding the first temperature range;
(D) an Operator Interface Terminal (OIT); and
(E) a processor operatively coupled to one or more of the laboratory water generation section, the laboratory water storage section, the laboratory water distribution section, and the OIT;
wherein the heated water distribution loop is configured to recycle a quantity of the laboratory water therein by returning same to the storage tank.

56. The system of claim 55, wherein the laboratory water distribution section comprises a first cooled water distribution loop and a second cooled water distribution loop in fluid communication with the laboratory water storage tank.

57. The system of claim 55, wherein the laboratory water generation section is configured to generate reverse osmosis de-ionized (RODI) water.

58. The system of claim 57, wherein the cooled water distribution loop is configured to distribute cooled reverse osmosis de-ionized (CRODI) water.

59. The system of claim 58, wherein the heated water distribution loop is configured to distribute heated reverse osmosis de-ionized (HRODI) water.

60-74. (canceled)

75. The system of claim 55, wherein the laboratory water in the cool water distribution loop is maintained at a temperature between about 18° C. to about 25° C.

76. (canceled)

77. The system of claim 55, wherein the heated water distribution loop is configured to heat and maintain the laboratory water therein to a temperature between about 53° C. to about 57° C.

78. The system of claim 77, wherein the heated water distribution loop is configured to cool the laboratory water therein to a temperature between about 18° C. to about 25° C. prior to returning the laboratory water to the storage tank.

79-83. (canceled)

84. The system of claim 55, wherein the system comprises two cooled water distribution loops.

85. A method of generating laboratory water and distributing laboratory water at different temperatures, the method comprising the steps of:
(A) treating potable water in laboratory water generation section to generate laboratory water; and
(B) transferring the laboratory water from the water generation section to a laboratory water storage tank of a laboratory water storage section;
(C) distributing the laboratory water using a laboratory water distribution section comprising:
(1) at least one cooled water distribution loop in fluid communication with the laboratory water storage tank, the cooled water distribution loop configured to receive the laboratory water from the storage tank and to distribute the laboratory water at a first temperature range through one or more outlets, and
(2) at least one heated water distribution loop in fluid communication with the laboratory water storage tank, the heated water distribution loop configured to receive the laboratory water from the storage tank and to distribute the laboratory water at a second temperature range through one or more outlets, the second temperature range exceeding the first temperature range; and
(D) recycling a quantity of water in the heated water distribution loop by returning same to the storage tank;
wherein the step of distributing is controlled by a at least one processor operatively coupled to one or more of the laboratory water generation section, the laboratory water storage section, and the laboratory water distribution section.

86. The method of claim 85, wherein the laboratory water distribution section comprises a first cooled water distribution loop and a second cooled water distribution loop in fluid communication with the laboratory water storage tank.

87. The method of claim 85, wherein the laboratory water generation section is configured to generate reverse osmosis de-ionized (RODI) water.

88. The method of claim 85, wherein the cooled water distribution loop is configured to distribute cooled reverse osmosis de-ionized (CRODI) water.

89. The method of claim 87, wherein the heated water distribution loop is configured to distribute heated reverse osmosis de-ionized (HRODI) water.

90-92. (canceled)

93. The method of claim 85, further comprising steps that are controlled by the processor:
receiving a heating input related to a set point temperature for water;
heating a first quantity of water within the heated water distribution loop from a baseline temperature to the set point temperature;
maintaining the first quantity of water at the set point temperature for a period of time;
preserving a second quantity of water within the cooled water distribution loop at the baseline temperature for the period of time;
cooling the first quantity of water from the set point temperature to the baseline temperature in response to a trigger; and
recycling the first quantity of water by transferring same to the storage tank when the first quantity of water is cooled to the baseline temperature.

94. The method of claim 93, wherein the heating input comprises a request for heated water at the set point temperature.

95. The method of claim 93, wherein the trigger comprises a notification that the period of time has reached a predetermined time limit.

96. The method of claim 93, wherein the heating input comprises a time limit, wherein the trigger comprises a notification that the period of time has reached the time limit.

97-100. (canceled)

101. The method of claim 85, wherein the laboratory water generation section comprises a multimedia filter, a cartridge filter, a water softening medium, an activated carbon bed, a reverse osmosis unit, a UV light, an ion exchange bed vessel and a mixed bed ion exchange vessel.

102. The method according to claim 85, wherein the laboratory water in the cooled water distribution loop is maintained at a temperature between about 18° C. to about 25° C.

103. (canceled)

104. The method of claim 85, wherein laboratory water in the heated water distribution loop is heated to and maintained at a temperature between about 53° C. to about 57° C.

105. (canceled)

106. (canceled)

107. The method of claim 85, further comprising one or more cooled water distribution outlets connected to the cooled water distribution loop and one or more heated water distribution outlets connected to the heated water distribution loop.

108. The method of claim 107, wherein the cooled water distribution loop dispenses laboratory water to the one or more cooled water distribution outlets, and wherein the one or more cooled water distribution outlets comprise one or more laboratory faucets.

109. The method of claim 108, wherein the heated water distribution loop dispenses laboratory water to the one or more heated water distribution outlets, where the one or more heated water distribution outlets comprise one or more faucets for mixing buffers or media.

110. The method of claim 85, further comprising the step of recycling a quantity of water in the cooled water distribution loop by returning same to the storage tank.
